(19) United States
(12) Patent Application Publication
(10) Pub. No.: US 2010/0312596 A1
(43) Pub. Date: Dec. 9, 2010

(54) ECOSYSTEM FOR SMART CONTENT TAGGING AND INTERACTION

(75) Inventors: Bob Saffari, San Carlos, CA (US); Gregory Maertens, Cernusco S/N (IT); Valentino Miazzo, Macherio (IT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mozaik Multimedia, Inc., Redwood City, CA (US)

(21) Appl. No.: 12/795,397

(22) Filed: Jun. 7, 2010

Related U.S. Application Data
(60) Provisional application No. 61/184,714, filed on Jun. 5, 2009.
(60) Provisional application No. 61/286,791, filed on Dec. 16, 2009.
(60) Provisional application No. 61/286,787, filed on Dec. 16, 2009.

(51) Int. Cl. G06F 17/30; G06F 9/44

(52) U.S. Cl. 705/7; 707/736; 707/E17.044; 707/769; 707/E17.005; 707/E17.014

(57) ABSTRACT

In various embodiments, a platform is provided for interactive user experiences. One or more tags may be associated with content. Each tag may correspond to at least one item represented in the content. Items represented in the content may include people, places, phrases, goods, services, etc. The platform may determine what information to associate with each tag in the one or more tags. One or more links between each tag in the one or more tags and determined information may be generated based on a set of business rules. Accordingly, links may be static or dynamic, in that they may change over time when predetermined criteria is satisfied. The links may be stored in a repository accessible consumers of the content such that selection of a tag in the one or more tags by the consumer of the content causes determined information associated with the tag to be presented to the consumer of the content.

### CROSS-REFERENCES TO RELATED APPLICATIONS

This Application claims the benefit of and priority to co-pending U.S. Provisional Patent Application No. 61/184,714, filed Jun. 5, 2009 and entitled “Ecosystem For Smart Content Tagging And Interaction;” co-pending U.S. Provisional Patent Application No. 61/286,791, filed Dec. 16, 2009 and entitled “Personalized Interactive Content System and Method;” and co-pending U.S. Provisional Patent Application No. 61/286,787, filed Dec. 19, 2009 and entitled “Personalized and Multiuser Content System and Method;” which are hereby incorporated by reference for all purposes.

This Application hereby incorporates by reference for all purposes commonly owned and co-pending U.S. patent application Ser. No. 12/471,161, filed May 22, 2009 and entitled “Secure Remote Content Activation and Unlocking” and commonly owned and co-pending U.S. patent application Ser. No. 12/485,312, filed Jun. 16, 2009 and entitled “Movie Experience Immersive Customization.”

### BACKGROUND OF THE INVENTION

The ability to search content using search engine and other automated way has been a key progress when dealing with the amount of data available on the World Wide Web. To date, there is no simple, automated way to identify the content of an image or a video. That has lead to the use of “tags.” These tags can then used, for example, as indexes by search engines. However, this model, which has some success on the Internet, suffers from a scalability issue.

Advanced set top-boxes, next generation Internet-enabled media players, such as Blu-ray and Internet-enabled TVs, bring a new era in the living room. In addition to higher quality pictures and a better sound, many devices can be connected to networks, such as the Internet. Interactive television has been around for quite some time already and many interactive ventures have failed along the way. The main reason is the user behavior in front of the TV is not the same as the one in front of a computer.

When analyzing the user experience while watching a movie, it is quite frequent at the end or even during the movie, to ask oneself: “what is that song from?”, “where did I see this actor before?”, “what is the name of this monument?”, “where can I buy those shoes?”, “how much does it cost to go there?”, etc. At the same time the user do not want to be disturbed with information he is not interested in or, if he is watching the movie with other people, is not polite to interrupt the movie experience to obtain information on the topic of his interest.

Accordingly, what is desired is to solve problems relating to the interaction of users with content, some of which may be discussed herein. Additionally, what is desired is to reduce drawbacks related to tagging and indexing content, some of which may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be to present some innovations, embodiments, and/or examples found within this disclosure in a simplified form as a prelude to a more detailed description presented later.

In addition to knowing more about items represented in content, such as people, places, and things in a movie, TV show, music video, image, or song, some natural next steps are to purchase the movie soundtrack, get quotes about a trip to a destination featured in the movie or TV show, etc. While some of the purchase can be completed from the living room experience, some others would require further involvement from the user.

In various embodiments, a platform is provided for interactive user experiences. One or more tags may be associated with content. Each tag may correspond to at least one item represented in the content. Items represented in the content may include people, places, goods, services, etc. The platform may determine what information to associate with each tag in the one or more tags. One or more links between each tag in the one or more tags and determined information may be generated based on a set of business rules. Accordingly, links may be static or dynamic, in that they may change over time when predetermined criteria are satisfied. The links may be stored in a repository accessible to consumers of the content such that selection of a tag in the one or more tags by the consumer of the content causes determined information associated with the tag to be presented to the consumer of the content.

In various embodiments, method and related systems and computer-readable media are provided for tagging people, product, places, phrases, sound tracks and services for user generated content or professional content based on single-click tagging technology for still and moving pictures.

In various embodiments, method and related systems and computer-readable media are provided for single, multi-angle view and specially stereoscopic (3DTV) tagging and delivering interactive viewing experience.

In various embodiments, method and related systems and computer-readable media are provided for interacting with visible or invisible (transparent) tagged content

In various embodiments, method and related systems and computer-readable media are provided for embedding tags when sharing a scene from a movie that has one or more tagged items visible or transparent and/or simply a tagged object (people, products, places, phrases, and services) from a content and distributing them across social networking sites and then tracing and tracking activities of tagged items as the content (still picture or video clips with tagged items) propagates through many personal and group sharing sites via online, on the web, or just on a local storage forming mini communities.

In some aspects, an ecosystem for smart content tagging and interaction is provided in any two way IP enabled platform. Accordingly, the ecosystem may incorporate any type of content and media, including commercial and non-commercial content, user-generated, virtual and augmented reality, games, computer applications, advertisements, or the like.

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 is a simplified illustration of a platform for smart content tagging and interaction in one embodiment according to the present invention.

FIG. 2 is a flowchart of a method for providing smart content tagging and interaction in one embodiment according to the present invention.

FIG. 3 is a flowchart of a method for tagging content in one embodiment according to the present invention.

FIGS. 4A, 4B, 4C, and 4D are illustrations of exemplary user interfaces for a tagging tool in one embodiment according to the present invention.

FIG. 5 is a block diagram representing relationships between tags and tag associated information in one embodiment according to the present invention.

FIG. 6 is a flowchart of a method for dynamically associating tags with tag associated information in one embodiment according to the present invention.

FIG. 7 is a flowchart of a method for interacting with tagged content in one embodiment according to the present invention.

FIGS. 8A and 8B are illustrations of how a user may interact with tagged content in various embodiments according to the present invention.

FIG. 9 illustrates an example of a piece of content with encoded interactive content using the platform of FIG. 1 in one embodiment according to the present invention.

FIGS. 10A, 10B, and 10C illustrate various scenes from a piece of interactive content in various embodiments according to the present invention.

FIGS. 11A, 11B, and 11C illustrate various menus associated with a piece of interactive content in various embodiments according to the present invention.

FIG. 12 illustrates an example of a shopping cart in one embodiment according to the present invention.

FIGS. 13A, 13B, 13C, 13D, 13E, and 13F are examples of user interfaces for purchasing items and/or interactive content in various embodiments according to the present invention.

FIGS. 14A, 14B, and 14C are examples of user interfaces for tracking items within difference scenes of interactive content in various embodiments according to the present invention.

FIG. 15 illustrates an example of user interface associated with a computing device when the computing device is used as a companion device in the platform of FIG. 1 in one embodiment according to the present invention.

FIG. 16 illustrates an example of a computing device user interface when the computing device is being synched to a particular piece of content being consumed by a user in one embodiment according to the present invention.

FIG. 17 illustrates an example of a computing device user interface showing details of a particular piece of content in one embodiment according to the present invention.

FIG. 18 illustrates an example of a computing device user interface once a computing device is synched to a particular piece of content and has captured a scene in one embodiment according to the present invention.

FIG. 19 illustrates an example of a computing device user interface when a user has selected a piece of interactive content in a synched scene of the piece of content in one embodiment according to the present invention.

FIG. 20 illustrates multiple users each independently interacting with content using the platform of FIG. 1 in one embodiment according to the present invention.

FIG. 21 is a flowchart of a method for sharing tagged content in one embodiment according to the present invention.

FIG. 22 is a flowchart of a method for determining behaviors or trends from users interacting with tagged content in one embodiment according to the present invention.

FIG. 23 is a simplified illustration of a system that may incorporate an embodiment of the present invention.

FIG. 24 is a block diagram of a computer system or information processing device that may incorporate an embodiment, be incorporated into an embodiment, or be used to practice any of the innovations, embodiments, and/or examples found within this disclosure.

### DETAILED DESCRIPTION OF THE INVENTION

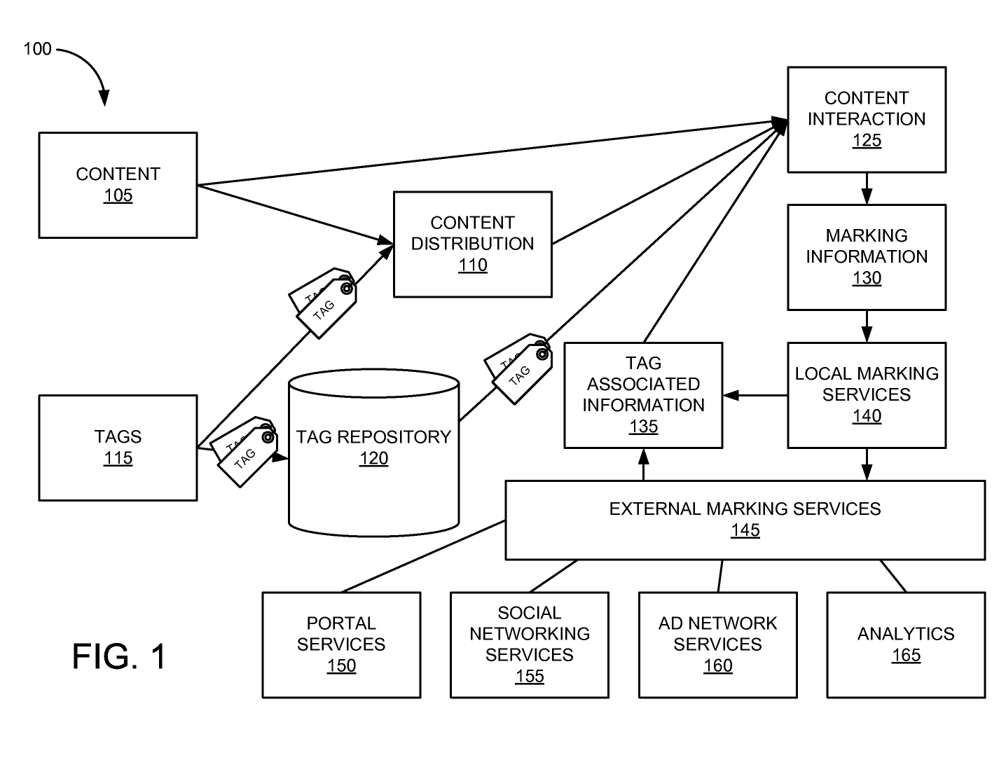

One or more solutions to providing rich content information along with non-invasive interaction can be described using FIG. 1. The following paragraphs describe the figure in details. FIG. 1 may merely be illustrative of an embodiment or implementation of an invention disclosed herein should not limit the scope of any invention as recited in the claims. One of ordinary skill in the art may recognize through this disclosure and the teachings presented herein other variations, modifications, and/or alternatives to those embodiments or implementations illustrated in the figures.

Ecosystem for Smart Content Tagging and Interaction

FIG. 1 is a simplified illustration of platform 100 for smart content tagging and interaction in one embodiment according to the present invention. In this example, platform 100 includes access to content 105. Content 105 may include textual information, audio information, image information, video information, content metadata, computer programs or logic, or combinations of textual information, audio information, image information, video information, and computer programs or logic, or the like. Content 105 may take the form of movies, music videos, TV shows, documentaries, music, audio books, images, photos, computer games, software, advertisements, digital signage, virtual or augmented reality, sporting events, theatrical showings, live concerts, or the like.

Content 105 may be professionally created and/or authored. For example, content 105 may be developed and created by one or more movie studios, television studios, recording studios, animation houses, or the like. Portions of content 105 may further be created or develops by additional third parties, such as visual effect studios, sound stages, restoration houses, documentary developers, or the like. Furthermore, all or part of content 105 may be user-generated. Content 105 further may be authored using or formatted according to one or more standards for authoring, encoding, and/or distributing content, such as the DVD format, Blu-ray format, HD-DVD format, H.264, IMAX, or the like.

In one aspect of supporting non-invasive interaction of content 105, platform 100 can provide one or more processes or tools for tagging content 105. Tagging content 105 may involve the identification of all or part of content 105 or objects represented in content 105. Creating and associating tags 115 with content 105 may be referred to as metalogging. Tags 115 can include information and/or metadata associated with all or a portion of content 105. Tags 115 may include numbers, letters, symbols, textual information, audio information, image information, video information, or the like, or a audio/visual/sensory representation of the like, that can be used to refer to all or part of content 105 and/or objects represented in content 105. Objects represented in content 105 may include people, places, phrases, items, locations, services, sounds, or the like.

In one embodiment, each of tags 115 can be expressed as a non-hierarchical keyword or term. For example, at least one of tags 115 may refer to a spot in a video where the spot in the video could be a piece of wardrobe. In another example, at least one of tags 115 may refer to information that a pair of from Levi's 501 blue jeans is present in the video. Tag metadata may describe an object represented in content 105 and allow it to be found again by browsing or searching.

In some embodiments, content 105 may be initially tagged by the same professional group that created content 105 (e.g., when dealing with premium content created by Hollywood movie studios). Content 105 may be tagged prior to distribution to consumers or subsequent to distribution to consumers. One or more types of tagging tools can be developed and provided to professional content creators to provide accurate and easy ways to tag content. In further embodiments, content 105 can be tagged by 3rd parties, whether affiliated with the creator of content 105 or not. For example, studios may outsource the tagging of content to contractors or other organizations and companies. In another example, a purchaser or end-user of content 105 may create and associate tags with content 105. Purchases or end-users of content 105 that may tag content 105 may be home users, members of social networking sites, members of fan communities, bloggers, members of the press, or the like.

Tags 115 associated with content 105 can be added, activated, deactivated, and/or removed at will. For example, tags 115 can be added to content 105 after content 105 has been delivered to consumers. In another example, tags 115 can be turned on (activated) or turned off (deactivated) based on user settings, content producer requirements, regional restrictions or locale settings, location, cultural preferences, age restrictions, or the like. In yet another example, tags 115 can be turned on (activated) or turned off (deactivated) based on business criteria, such as whether a subscriber has paid for access to tags 115, whether a predetermined time period has expired, whether an advertiser decides to discontinue sponsorship of a tag, or the like.

Referring again to FIG. 1, in another aspect of supporting non-invasive interaction of content 105, platform 100 can include content distribution 110. Content distribution 110 can include or refer to any mechanism, services, or technology for distributing content 105 to one or more users. For example, content distribution 110 may include the authoring of content 105 to one or more optical discs, such as CDs, DVDs, HD-DVDs, Blu-ray Disc, or the like. In another example, content distribution 110 may include the broadcasting of content 105, such as through wired/wireless terrestrial radio/TV signals, satellite radio/TV signals, WIFI/WIMAX, cellular distribution, or the like. In yet another example, content distribution 110 may include the streaming or on-demand delivery of content 105, such as through the Internet, cellular networks, IPTV, cable and satellite networks, or the like.

In various embodiments, content distribution 110 may include the delivery of tags 115. In other embodiments, content 105 and tags 115 may be delivered to users separately. For example, platform 100 may include tag repository 120. Tag repository 120 can include one or more databases or information storage devices configured to store tags 115. In various embodiments, tag repository 120 can include one or more databases or information storage devices configured to store information associated with tags 115 (e.g., tag associated information). In further embodiments, tag repository 120 can include one or more databases or information storage devices configured to links or relationships between tags 115 and tag associated information (TAI). Tag repository 120 may be accessible to creators or provides of content 105, creators or providers of tags 115, and to ends users of content 105 and tags 115.

In various embodiments, tag repository 120 may operation as a cache of links between tags and tag associated information supporting content interaction 125.

Referring again to FIG. 1, in another aspect of supporting non-invasive interaction of content 105, platform 100 can include content interaction 125. Content interaction 125 can include any mechanism, services, or technology enabling one or more users to consume content 105 and interact with tags 115. For example, content interaction 125 can include various hardware and/or software elements, such as content playback devices or content receiving devices, such as those supporting embodiments of content distribution 110. For example, a user or group of consumers may consume content 105 using a Blu-ray disc player and interact with tags 115 using a corresponding remote control or using a companion device, such as a dedicated device, smartphone, IPHONE, tablet, IPAD, IPOD TOUCH, or the like.

In another example, a user or group of consumers may consume content 105 using an Internet-enabled set top box and interact with tags 115 using a corresponding remote control or using a companion device, such as a dedicated device, smartphone, IPHONE, tablet, IPAD, IPOD TOUCH, or the like.

In yet another example, a user or group of consumers may consume content 105 at a movie theater or live concert and interact with tags 115 using a companion device, such as a dedicated device, smartphone, IPHONE, tablet, IPAD, IPOD TOUCH, or the like.

In various embodiments, content interaction 125 may provide a user with one or more aural and/or visual representation or other sensory input indicating presences of a tagged item or object represented within content 105. For example, highlighting or other visual emphasis may be used on, over, near, or about all or a portion of content 105 to indicate that something in content 105, such as a person, location, product or item, scene of a feature film, etc. has been tagged. In another example, images, thumbnails, or icons may be used to indicate that something in content 105, such as an item in a scene, has been tagged, therefore, it could be searched.

In one example, a single icon or other visual representation popping up on a display device may provide an indication that something is selectable in the scene. In another example, several icons may pop up on a display device in an area outside of displayed content for each selectable element. In yet another example, an overlay may be provided on top of content 105. In a further example, a list or listing of items may be provided in an area outside of displayed content. In yet a further example, nothing may be represented to the user at all while everything in content 105 is selectable. The user may be informed that something in content 105 has been tagged through one or more different, optional, or other means. These means may be configured via user preferences or other device settings.

In further embodiments, content interaction 125 may not provide any sensory indication that tagged items are available. For example, while tagged items may not be displayed on a screen or display device as active links, hot spots, or action points, metadata associated with each scene can contain information indicating that tagged items are available. These tags may be referred to as transparent tagged items (e.g., they are presented but not necessarily seen). Transparent tags may be activated via a companion device, smartphone, IPAD, etc. and the tagged items could be stored locally where media is being played or could be stored on one or more external devices, such as a server.

The methodology of content interaction 125 for tagging and interacting with content 105 can be applicable to a variety of types of content 105, such as still images as well as moving pictures regardless of resolution (mobile, standard definition video or HDTV video) or viewing angle. Furthermore, tags 115 and content interaction 125 are equally applicable to standard viewing platforms, live shows or concerts, theater venues, as well as multi-view (3D or stereoscopic) content in mobile, SD, HDTV, IMAX, and beyond resolution.

Content interaction 125 may allow a user to mark items of interest in content 105. Items of interest to a user may be marked, selected, or otherwise designated as being of interest. As discussed above, a user may interact with content 105 using a variety of input means, such as keyboards, pointing devices, touch screens, remote controls, etc., to mark, select or otherwise indicate one or more items of interest in content 105. A user may navigate around tagged items on a screen. For example, content interaction 125 may provide one or more user interfaces that enable, such as with a remote control, L, R, Up, Down options or designations to select tagged items. In another example, content interaction 125 may enable tagged items to be selected on a companion device, such as by showing a captured scene and any items of interest, and using the same tagged item scenes.

As a result of content interaction 125, marking information 130 is generated. Marking information 130 can include information identifying one or more items marks or otherwise identified by a user to be of interest. Marking information 130 may include one or more marks. Marks can be stored locally on a user's device and/or sent to one or more external devices, such as a Marking Server.

During one experience of interacting with content 105, such as watching a movie or listening to a song, a user may mark or otherwise select items or other elements within content 105 which are of interest. Content 105 may be paused or frozen at its current location of playback, or otherwise halted during the marking process. After the process of marking one or more items or elements in content 105, a user can immediately return to the normal experience of interacting with content 105, such as un-pausing a movie from the location at which the marking process occurred.

In the following examples are different, yet not exhaustive, ways from the least to the most intrusive of generating marking information 130.

Marking Example A. In this example, if a user is interested in something in a movie scene, one or more highlighting features can show the user whether something is markable. Additionally, one or more highlighting features can show the user whether something is not markable. The user then marks the whole scene without interrupting the movie.

Marking Example B. In this example, if a user is interested in something in a movie scene, one or more highlighting features can show the user that something is markable. The user then pauses the movie, marks the items of interest from a list of tags (e.g., tags 115), and un-pauses to return to the movie. If the user does not found any highlighting for an item of interest, the user can mark the whole scene.

Marking Example C. In this example, if a user is interested in something in a movie scene, one or more highlighting features can show the user that something is markable in a list of tags. The user then pauses the movie, but if the user does not find any highlighting for an item of interest in the list, then user can mark any interesting region of the scene.

In any of the above examples, a user can mark an item, items, or all or a portion of content 105 by selecting or touching a point of interest. If nothing is shown as being markable or selectable (e.g., there is no know corresponding tag), the user can either provide the information to create a tag or ask a third party for the information. The third party can be a social network, a group of friends, a company, or the like. For example, when a user marks a whole scene or part of it, some items, persons, places, services, etc. represented in content 105 may have not been tagged. For those unknown items, a user can add information (e.g., a Tag name, a category, an URL, etc.). As discussed above, tags 115 can include user generated tags.

Referring again to FIG. 1, in another aspect of supporting non-invasive interaction of content 105, platform 100 can include the delivery of tag associated information (TAI) 135 for tags 115. TAI 135 can include information, further content, and/or one or more actions. For example, if a user desires further information about an item, person, or place, the user can mark the item, person, or place, and TAI 135 corresponding to the tag for the marked item, person, or place can be presented. In another example, TAI 135 corresponding to the tag for the marked item, person, or place can be presented with allows the user to perform one or more actions, such as purchase the item, content or email the person, or book travel to the place of interest.

In some embodiments, TAI 135 is statically linked to tags 115. For example, the information, content, and/or one or more actions associated a tag does not expire, change, or is not otherwise modified during the life of content 115 or the tag. In further embodiments, TAI 135 is dynamically linked to tags 115. For example, platform 100 may include one or more computer systems configured to search and/or query one or more offline database, online database or information sources, 3^{rd} party information source, or the like for information to be associated with a tag. Search results from these one or more queries may be used to generate TAI 135. In one aspect, during various points of the lifecycle of a tag, business rules are applied to search results (e.g., obtained from one or more manual or automated queries) to determine how to associate information, content, or one or more action with a tag. These business rules may be managed by operators of platform 100, content providers, marketing departments, advertisers, creators of user-generated content, fan communities, or the like.

As discussed above, in some embodiments, tags 115 can be added, activated, deactivated, and/or removed at will. Accordingly, in some embodiments, TAI 135 can be dynamically added to, activated, deactivated, or removed from tags 115. For example, TAI 135 associated with tags 115 may change or be updated after content 105 has been delivered to consumers. In another example, TAI 115 can be turned on (activated) or turned off (deactivated) based on availability of an information source, availability of resources to complete one or more associated actions, subscription expirations, sponsorships ending, or the like.

In various embodiments, TAI 135 can be provided by local marking services 140 or external marking services 145. Local marking services 140 can include hardware and/or software elements under the user's control, such as the content playback device with which the user consumes content 105. In one embodiment, local marking services 140 provide only TAI 135 that has been delivered along with content 105. In another embodiment, local marking services 140 may provide TAI 135 that has been explicitly downloaded or selected by a user. In further embodiments, local marking services 140 may be configured to retrieve TAI 135 from one or more servers associated with platform 100 and cache TAI 135 for future reference.

In various embodiments, external marking services 145 may be provided by one or more 3rd parties for the delivery and handling of TAI 135. External marking services 145 may be accessible to a user's content playback device via a communications network, such as the Internet. External marking services 145 may directly provide TAI 135 and/or provide updates, replacements, or other modifications and changes to TAI 135 provided by local marking services 140.

In various embodiments, a user may gain access to further data and consummate transactions through external marking services 145. For example, a user may interact with portal services 150. At least one portal associated with portal services 150 can be dedicated to movie experience extension allowing a user to continue the movie experience (e.g., get more information) and have shopping opportunities for items of interest in the movie. In some embodiments, at least one portal associated with portal services 150 can include a white label portal/web service. This portal can provide white label services to movie studios. The service can be further integrated in their respective websites.

In further embodiments, external marking services 145 may provide communication streams to users. RSS feed, emails, forums, and the like provided by external marking services 145 can provide a user with direct access to other users or communities.

In still further embodiments, external marking services 145 can provide social network information to users. A user can access through widgets existing social networks (information and viral marketing for products and movie). Social network services 155 may enable users to share items represented in content 105 with other users in their networks. Social network services 155 may generate interactivity information that enables the other users with whom the items were shared to view TAI 135 and interact with the content much like the original user. The other users may further be able to add tags and tag associated information.

In various embodiments, external marking services 145 can provide targeted advertisement and product identification. Ad network services 160 can supplement TAI 135 with relevant content, value propositions, coupons, or the like.

In further embodiments, analytics 165 provides statistical services and tools. These services and tool can provide additional information on a user behavior and interest. Behavior and trend information provided by analytics 165 may be used to tailor TAI 135 to a user, enhance social network services 155 and Ad network services 160. Furthermore, behavior and trend information provided by analytics 165 may be used to determine product placement review and future opportunities, content sponsorship programs, incentives, or the like.

Accordingly, while some sources, such as Internet websites can provide information services, they fail to translate well into most content experiences, such as in a living room experience for television or movie viewing. In one example of operation of platform 100, a user can watch a movie and be provided the ability to mark a specific scene. Later, at the user discretion, the user can dig into the scene to obtain more information about people, places, items, effects, or other content represented in the specific scene. In another example of operation of platform 100, one or more of the scenes the user has marked or otherwise expressed an interest in can be shared among the user's friends on a social network, (e.g., Facebook). In yet another example of operation of platform 100, one or more products or services can be suggested to a user that match the user's interest in an item in a scene, the scene itself, a movie, genre, or the like.

Metalogging

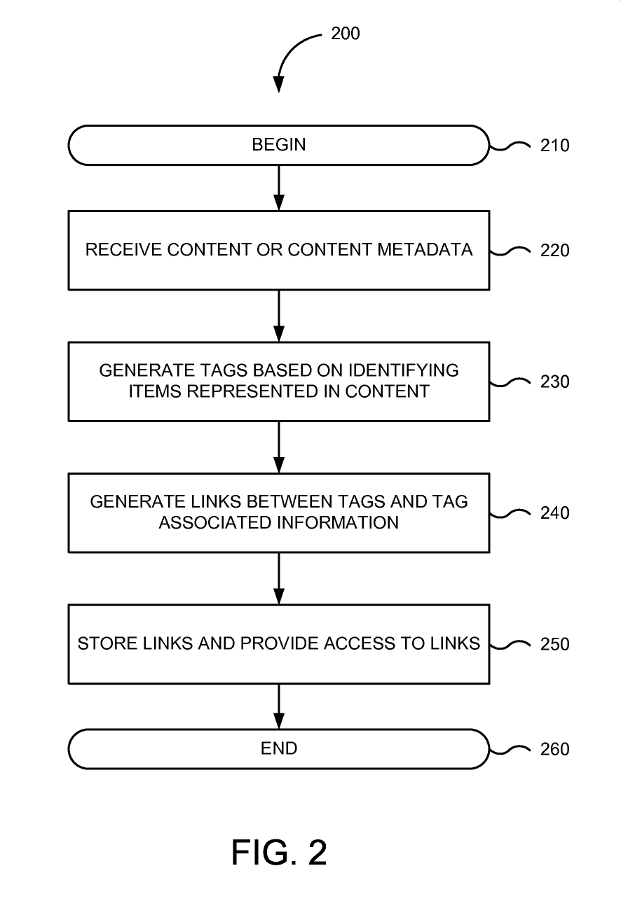

FIG. 2 is a flowchart of method 200 for providing smart content tagging and interaction in one embodiment according to the present invention. Implementations of or processing in method 200 depicted in FIG. 2 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 200 depicted in FIG. 2 begins in step 210.

In step 220, content or content metadata is received. As discussed above, the content may include multimedia information, such as textual information, audio information, image information, video information, or the like, computer programs, scripts, games, logic, or the like. Content metadata may include information about content, such as time code information, closed-captioning information, subtitles, album data, track names, artist information, digital restrictions, or the like. Content metadata may further information describing or locating objects represented in the content. The content may be premastered or broadcast in real-time.

In step 230, one or more tags are generated based on identifying items represented in the content. The process of tagging content may be referred to as metalogging. In general, a tag may identify all or part of the content or an object represented in content, such as an item, person, product, service, phrase, song, tune, place, location, building, etc. A tag may have an identifier than can be used to look up information about the tag and a corresponding object represented in content. In some embodiments, a tag may further identify the location of the item within all or part of the content.

In step 240, one or more links between the one or more tags and tag associated information (TAI) are generated. A link can include one or more relationships between a tag and TAI. In some embodiment, a link may include or be represented by one or more static relationships, in that an association between a tag and TAI never changes or changes infrequently. In further embodiments, the one or more links between the one or more tags and the tag associated information may have dynamic relationships. TAI to which a tag may be associated may change based on application of business rules, based on time, per user, based on payment/subscription status, based on revenue, based on sponsorship, or the like. Accordingly, the one or more links can be dynamically added, activated, deactivated, removed, or modified at any time and for a variety of reasons.

In step 250, the links are stored and access is provided to the links. For example, information representing the links may be stored in tag repository 120 of FIG. 1. In another example, information representing the links may be stored in storage devices accessible to local marking services 140 or external marking services 145. FIG. 2 ends in step 260.

In various embodiments, one or more types of tools can be developed to provide accurate and easy ways to tag and metalog content. Various tools may be targeted for different groups. In a variety of examples, platform 100 may provide one or more installable software tools that can be used by content providers to tag content. In further examples, platform 100 may provide one or more online services (e.g., accessible via the Internet), managed services, cloud services, or the like, that enable users to tag content without installing software. As such, tagging or meta-logging of content may occur offline, online, in real-time, or in non real-time. A variety of application-generated user interfaces, web-based user interfaces, or the like may be implemented using technologies, such as JAVA, HTML, XML, AJAX, or the like.

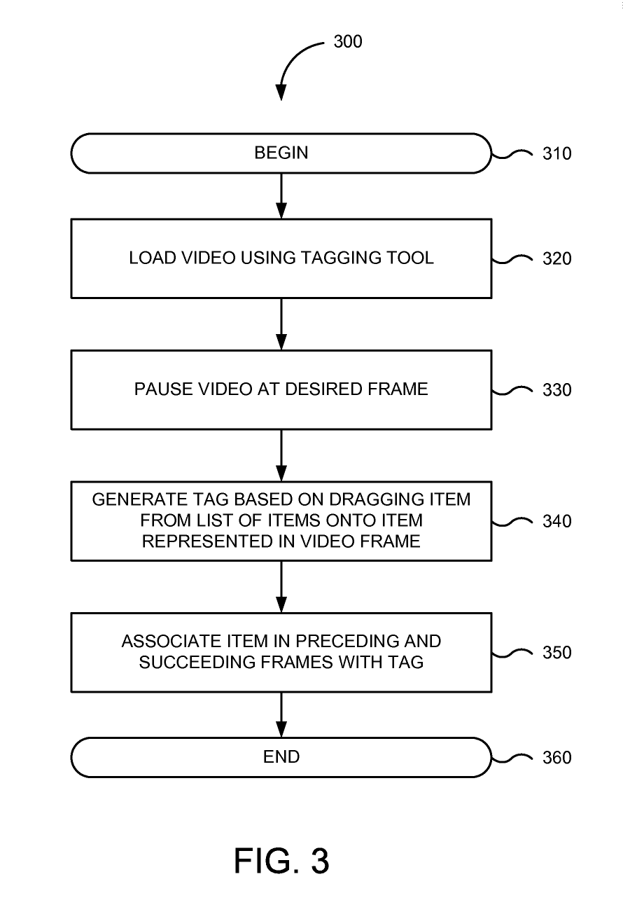

FIG. 3 is a flowchart of method 300 for tagging content in one embodiment according to the present invention. Implementations of or processing in method 300 depicted in FIG. 3 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 300 depicted in FIG. 3 begins in step 310.

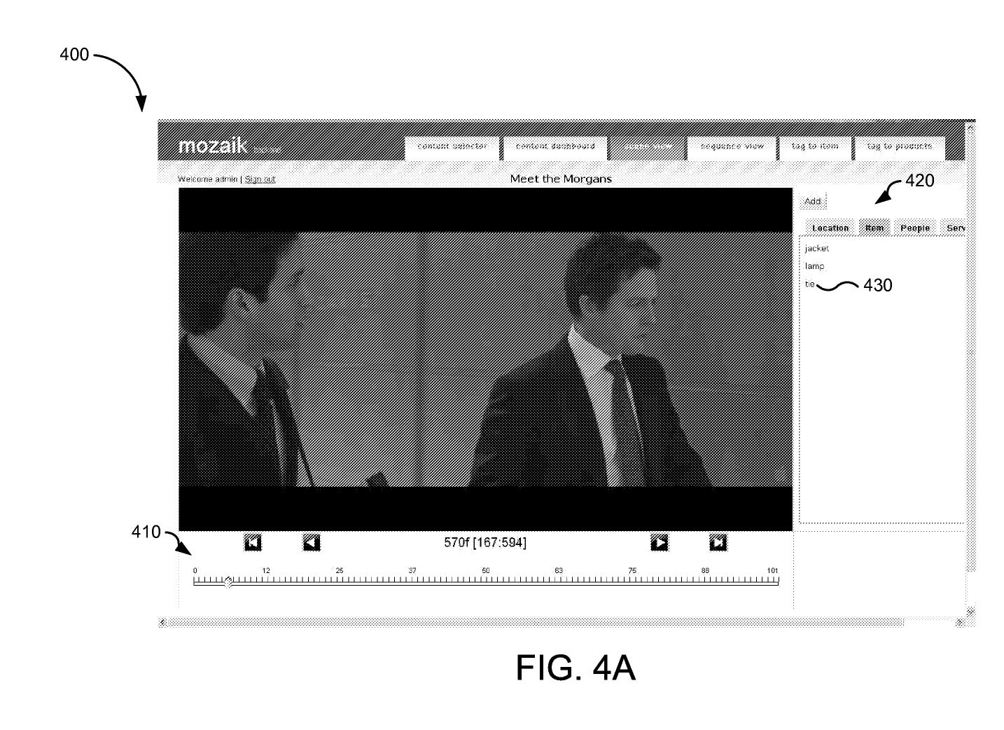

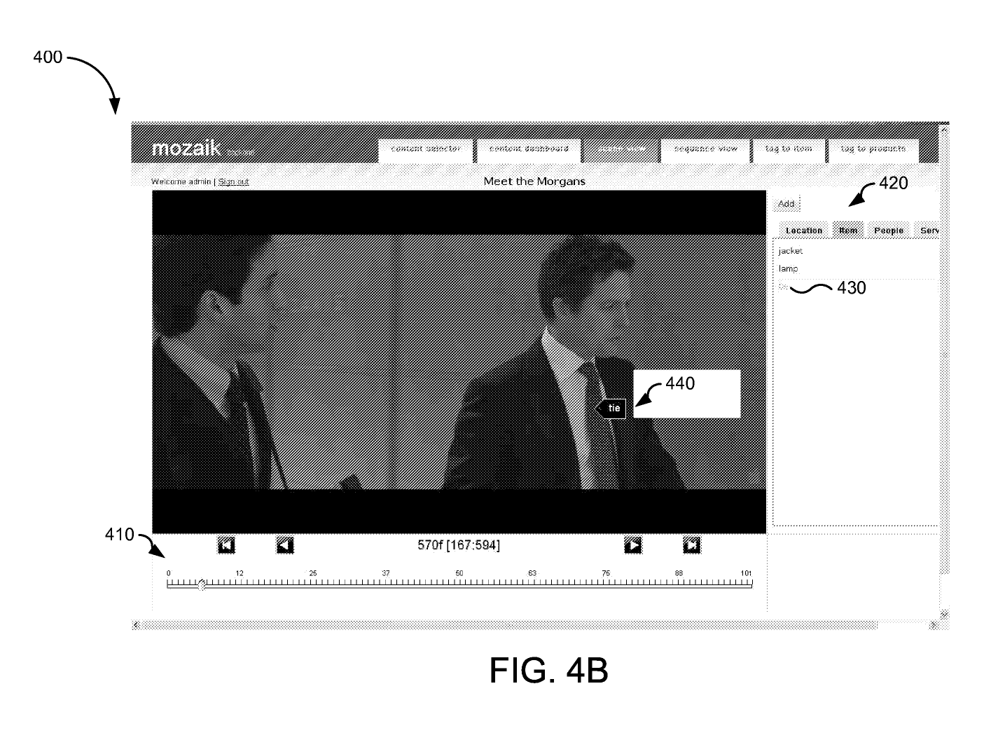

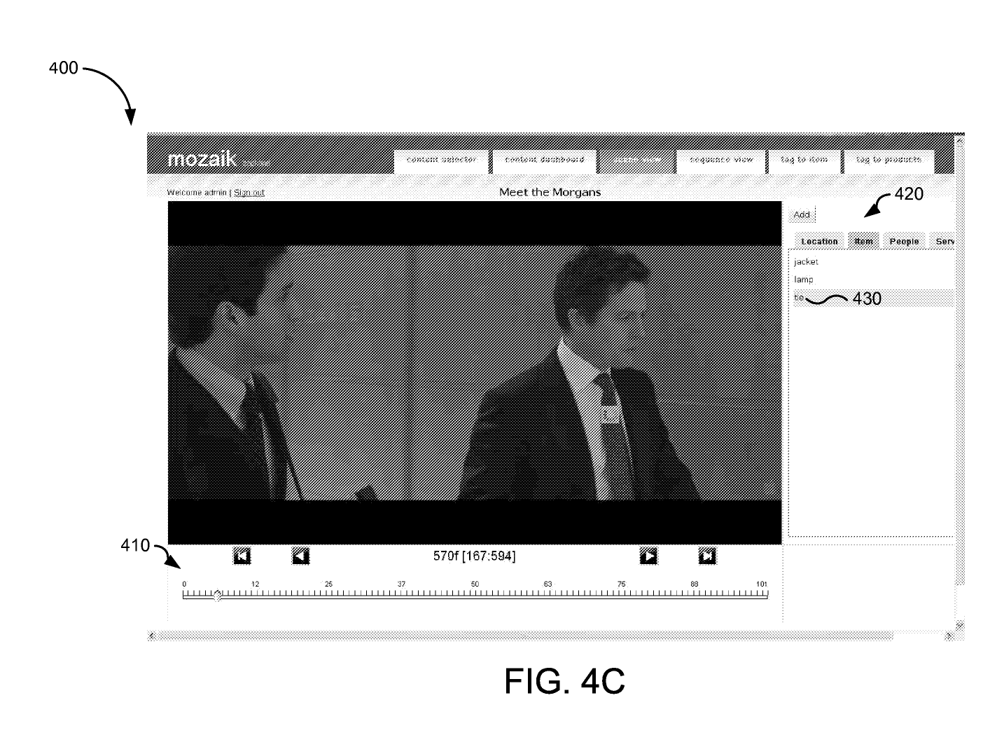

In an example of working with video, in step 320, one or more videos are loaded using a tagging tool. The one or more videos may be processed offline (using associated files) or on the fly for real-time or live events. As discussed above, the tagging tool may be an installable software product, functionality provided by a portion of a website, or the like. For example, FIG. 4A is an illustration of an exemplary user interface 400 for a tagging tool in one embodiment according to the present invention. User interface 400 may include functionality for opening a workspace, adding content to the workspace, and performing metalogging on the content. In this example, a user may interact with user interface 400 to load content (e.g., “Content Selector” tab).

User interface 400 further may include one or more controls 410 enabling a user to interact the content. Controls 410 may include widgets or other user interface elements, such as text boxes, radio buttons, check boxes, sliders, tabs, or the like. Controls 410 may be adapted to a variety of types of content. For example, controls 410 may include controls for time-based media (e.g., audio/video), such as a play/pause button, a forward button, a reverse button, a forward all button, a reverse all button, a stop button, a slider allowing a user to select a desired time index, or the like. In another example, controls 410 may include controls enabling a user to edit or manipulate images, create or manipulate presentations, control or adjust colors/brightness, create and/or modify metadata (e.g., MP3 ID tags), edit or manipulate textual information, or the like.

In various embodiments, user interface 400 may further include one or more areas or regions dedicated to one or more tasks. For example, one region or window of user interface 400 may be configured to present a visual representation of content, such as display images or preview video. In another example, one region or window of user interface 400 may be configured to present visualizations of audio data or equalizer controls.

In yet another example, one region or window of user interface 400 may be configured to present predetermined items to be metalogged with content. In this example, user interface 400 includes one or more tabs 420. Each tab in tabs 420 may display a list of different types of objects that may be represented in content, such as locations, items, people, phrases, places, services, or the like.

Returning to FIG. 3, in step 330, the video is paused or stopped at a desired frame or at an image in a set of still images representing the video. A user may interact items in the lists of locations, items, people, places, services, or the like that may be represented in the video frame by selecting an item and dragging the item onto the video frame at a desired location of the video frame. The desired location may include a corresponding item, person, phrase, place, location, services, or any portion of content to be tagged. In this example, item 430 labeled as “tie” is selectable by a user for dragging onto the paused video. This process may be referred to as “one-click tagging” or “one-step tagging” in that a user of user interface 400 tags content in one click (e.g., using a mouse or other pointing device) or in one-step (e.g., using a touch screen or the like). Other traditional processes may require multiple steps.

In step 340, a tag is generated based on dragging an item from a list of items onto an item represented in the video frame. In this example, dragging item 430 onto the video frame as shown in FIG. 4B creates tag 440 entitled “tie.” Any visual representation may be used to represent that the location onto which the user dropped item 430 on the video frame has been tagged. For example, FIG. 4B illustrates that tag 440 entitled “tie” has been created on a tie represented in the video frame.

In various embodiments, the tagging tool computing an area automatically in the current frame for the item represented in the content onto which item 430 was dropped. FIG. 4C illustrates area 450 that corresponds to tag 440. The tagging tool then tracks area 440, for example, using Lucas-Kanade optical flow in pyramids in the current scene. In some embodiments, a user may designate area 450 for a single frame or on a frame-by-frame basis.

Various alternative processes may also be used, such as those described in “Multimedia Hypervideo Links for Full Motion Videos” IBM TECHNICAL DISCLOSURE BULLETIN, vol. 37, no. 4A, April 1994, NEW YORK, US, pages 95-96, XP002054828; U.S. Pat. No. 6,570,587 entitled “System And Method And Linking Information To A Video;” and U.S. Patent Application Publication No. 2010/0005408 entitled “System And Methods For Multimedia “Hot Spot” Enablement,” which are incorporated by reference for all purposes. In general, detection of an object region may start from a seed point, such as where a listed item is dropped onto the content. In some embodiment, local variations of features of selected points of interest are used to automatically track an object in the content which is more sensible to occlusions and to changes in the object size and orientation. Moreover, consideration may be made of context related information (like scene boundaries, faces, etc.). Prior art pixel-by-pixel comparison typically performs slower than techniques (such as eigenvalues for object detection and Lucas-Kanade optical flow in pyramids for object tracking)

In step 350, the item represented in the video frame is associated with tag in preceding and succeeding frames. This allows a user to tag an item represented in content once at any point at which the item presents itself and have a tag be generated that is associated with any instance or appearance of the item in the content. In various embodiments, a single object represented in content can be assigned to a tag uniquely identifying it, and the object can be linked to other type of resources (like text, video, commercials, etc.) and actions. When step 350 completes, the item associated with tag 440 and the tracking of it throughout the content can be stored in a database. FIG. 3 ends in step 360.

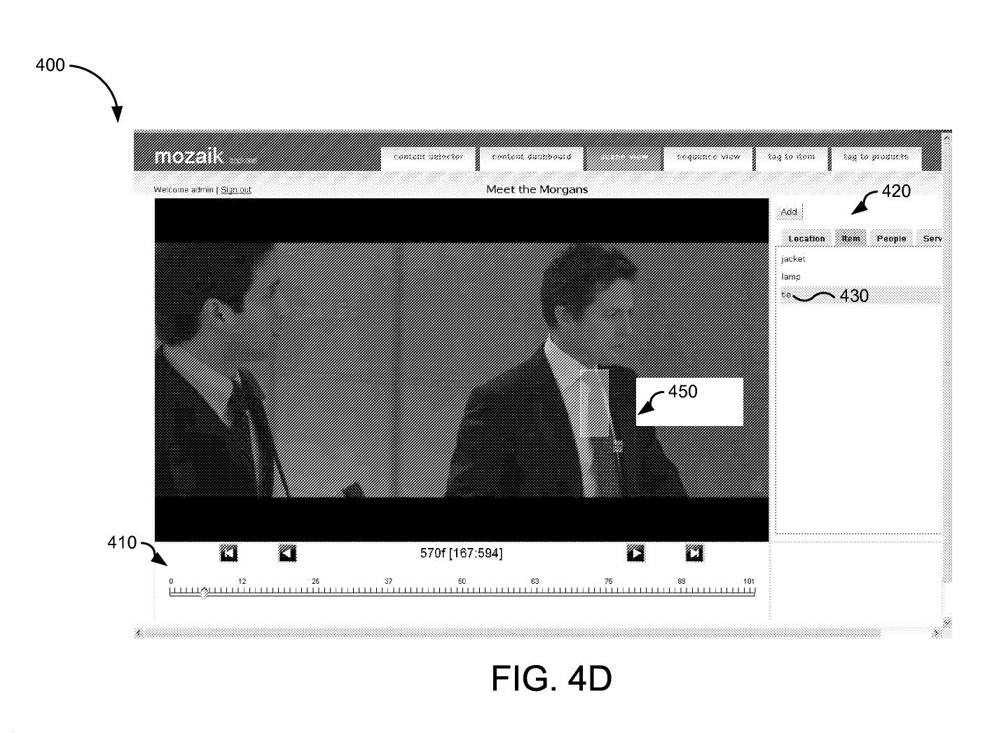

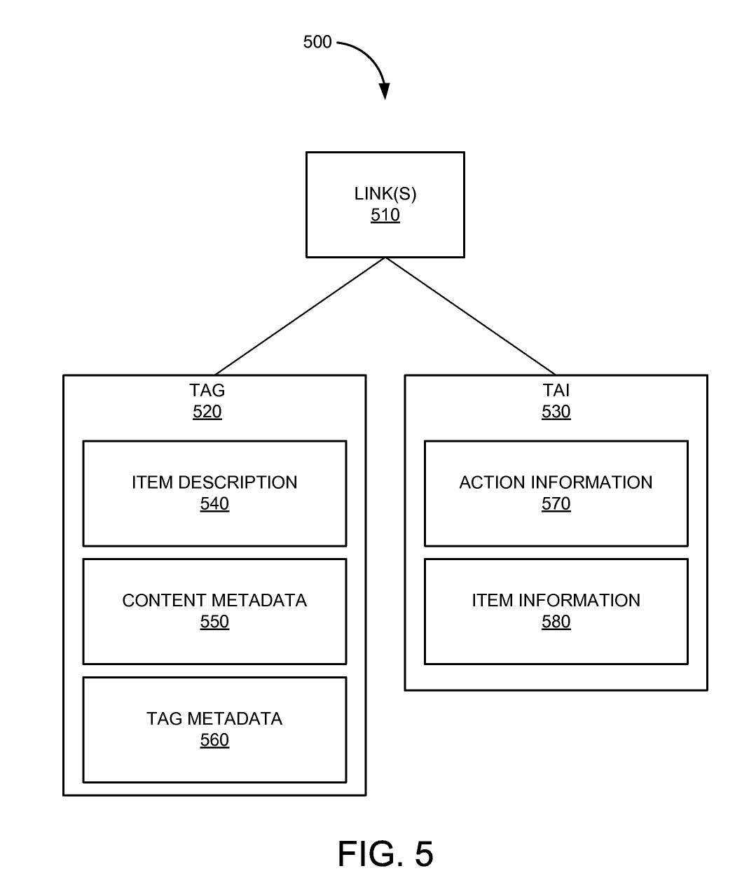

FIG. 5 is a block diagram representing relationships between tags and tag associated information in one embodiment according to the present invention. In this example, object 500 includes one or more links 510. Each of the one or more links 510 associates tag 520 with tag associated information (TAI) 530. Links 510 may be statically created or dynamically created and updated. For example, a content provider may hard code a link between a tag for a hotel represented in a movie scene and a URL at which a user may reserve a room at the hotel. In another example, a content provider may create an initial link between a tag for a product placement in a movie scene and a manufacturer's website. Subsequently, the initial link may be severed and one or more additional links may be created between the tag and retailers for the product.

Tag 520 may include item description 540, content metadata 550, and/or tag metadata 560. Item description 540 may be optionally included in tag 520. Item description 540 can include information, such as textual information or multimedia information, that describes or otherwise identifies a given item represented in content (e.g., a person, place, location, product, item, service, sound, voice, etc.). Item description 540 may include one or more item identifiers. Content metadata 550 may be optionally included in tag 520. Content metadata 550 can include information that identifies a location, locations, or instance where the given item can be found. Tag metadata 560 may be optionally included in tag 520. Tag metadata 560 can include information about tag 520, header information, payload information, service information, or the like. Item description 540, content metadata 550, and/or tag metadata 560 may be included with tag 520 or stored externally to tag 520 and used by reference.

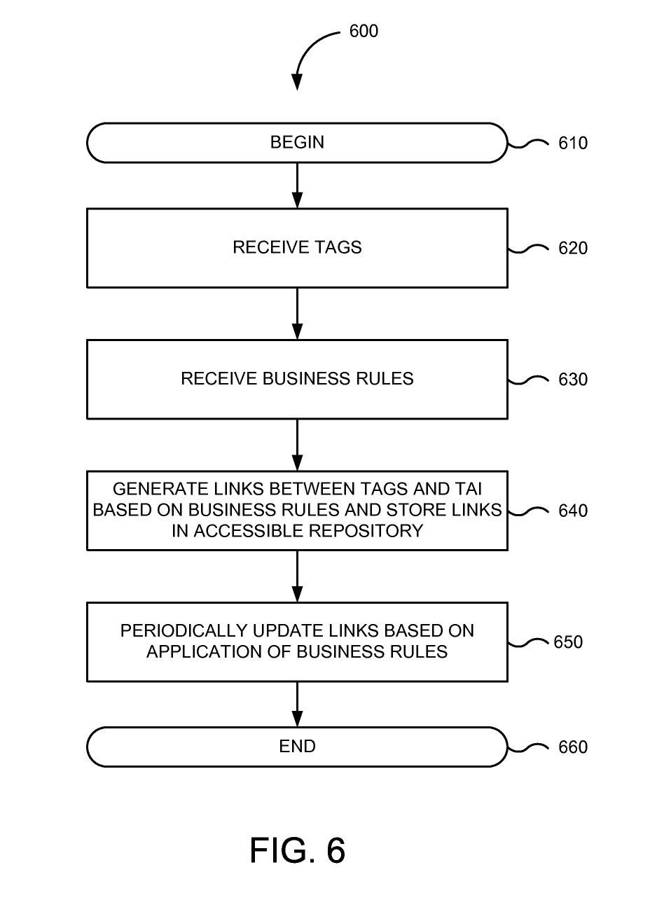

FIG. 6 is a flowchart of method 600 for dynamically associating tags with tag associated information in one embodiment according to the present invention. Implementations of or processing in method 600 depicted in FIG. 6 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 600 depicted in FIG. 6 begins in step 610.

In step 620, one or more tags are received. As discussed above, tags may be generated by content producers, users, or the like identifying items represented in content (such as locations, buildings, people, apparel, products, devices, services, etc.).

In step 630, one or more business rules are received. Each business rule determines how to associate information or an action with a tag. Information may include textual information, multimedia information, additional content, advertisements, coupons, maps, URLs, or the like. Actions can include interactivity options, such as viewing addition content about an item, browsing additional pieces of the content that include the item, adding the item to a shopping cart, purchasing the item, forwarding the item to another user, sharing the item on the Internet, or the like.

A business rule may include one or more criteria or conditions applicable to a tag (e.g., information associated with item description 540, content metadata 550, and/or tag metadata 560). A business rule may further identify information or an information source to be associated with a tag when the tag or related information satisfies the one or more criteria or conditions. A business rule may further identify an action to be associated with a tag when the tag or related information satisfies the one or more criteria or conditions. A business rule may further include logic for determining how to associate information or an action with a tag. Some examples of logic may include numerical calculations, determinations whether thresholds are meet or quotas exceeded, queries to external data sources and associated results processing, consulting analytics engines and applying the analysis results, consulting statistical observations and applying the statistical findings, or the like.

In step 640, one or more links between tags and TAI are generated based on the business rules. The links then may be stored in an accessible repository. In step 650, the one or more links are periodically updated based on application of the business rules. In various embodiments, application of the same rule may dynamically associate different TAI with a tag. In further embodiments, new or modified rules may cause different TAI to be associated with a tag. FIG. 6 ends in step 660.

Smart Content Interaction

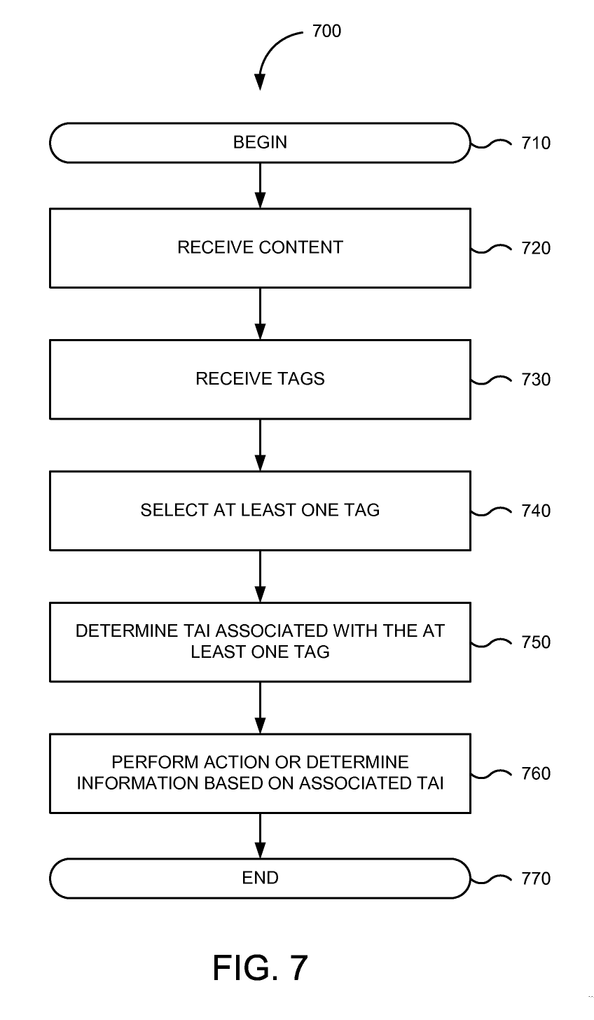

FIG. 7 is a flowchart of method 700 for interacting with tagged content in one embodiment according to the present invention. Method 700 in FIG. 7 begins in step 710. In step 720, content is received. As discussed above, content may be received via media distribution, broadcast distribution, streaming, on-demand delivery, live capture, or the like. In step 730, tags are received. As discussed above, tags may be received via media distribution, broadcast distribution, streaming, on-demand delivery, live capture, or the like. Tags may be received at the same device as the content. Tags may also be received at a different device (e.g., a companion device) than the content.

In step 740, at least one tag is selected. A user may select a tag while consuming the content. Additionally, a user may select a tag while pausing the content. A user may select a tag via a remote control, keyboard, touch screen, etc. A user may select a tag from a list of tags. A user may select an item represented in the content, and the corresponding tag will be selected. In some embodiments, the user may select a region of content or an entire portion of content, and any tags within the region or all tags in the entire portion of content are selected.

In step 750, TAI associated with the at least one tag is determined. For example, links between tags and TAI are determined or retrieved from a repository. In step 760, one or more actions are performed or information determined based on TAI associated with the at least one tag. For example, an application may be launched, a purchase initiated, an information dialog displayed, a search executed, or the like. FIG. 7 ends in step 770.

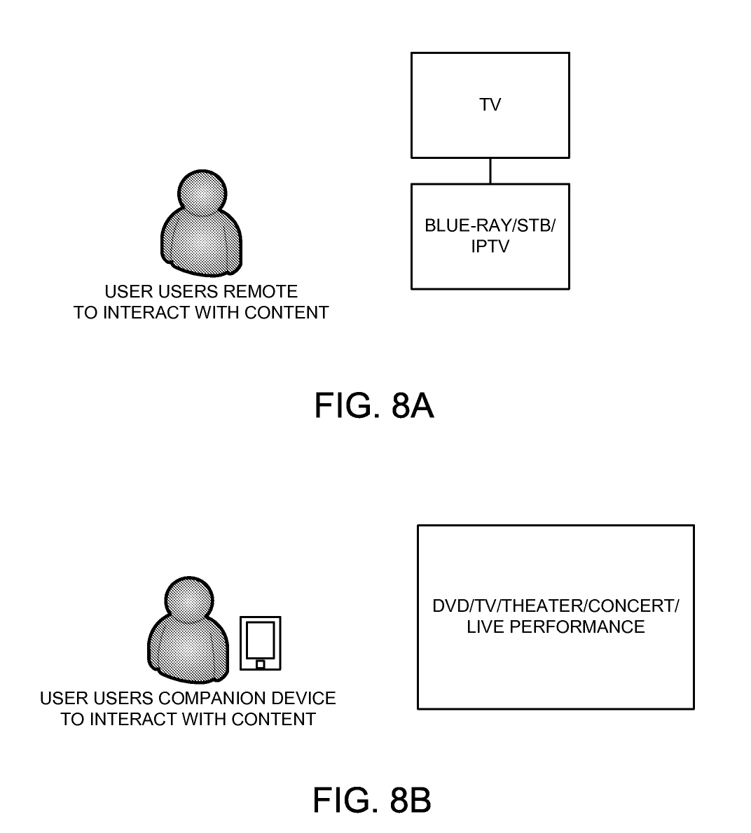

FIGS. 8A and 8B are illustrations of how a user may interact with tagged content in various embodiments according to the present invention.

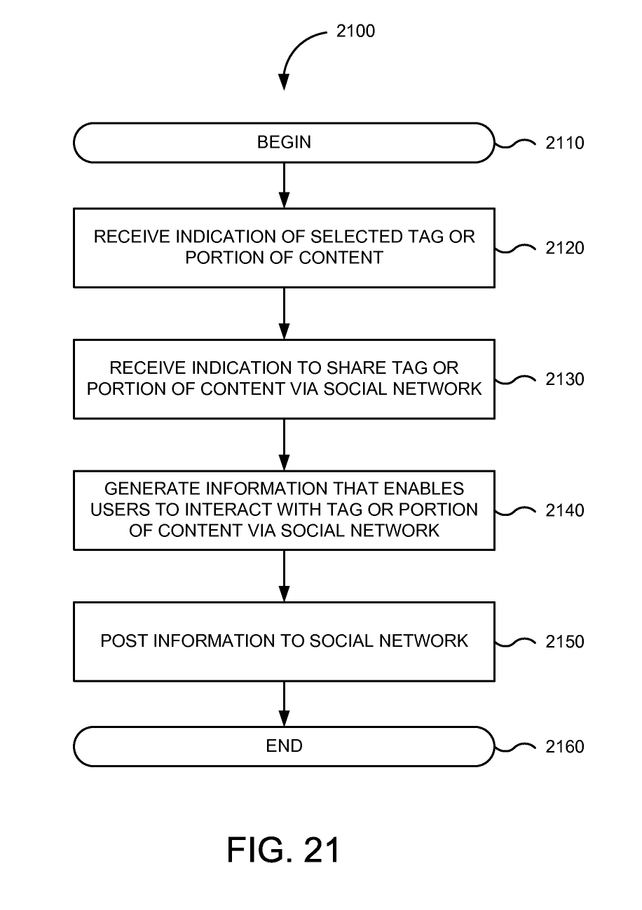

FIG. 21 illustrates an example of content tagged or metalogged using platform 100 of FIG. 1 in one embodiment according to the present invention. In this example, content 2100 includes encoded interactive content based on original content that has been processed by platform 100 (e.g., metalogging). In the scene shown, one or more interactive content markers 2110 (e.g., visual representations of tags 115) are shown wherein each interactive content marker indicates that a tag and potentially additional information is available about a piece of interactive content in the piece of content. For example, one of interactive content markers 2110 marking the bow tie worn by a person in the scene indicates that tag associated information (e.g., further information and/or one or more actions) is available about the bowtie. Similarly, one of interactive content markers 2110 marking the tuxedo worn by a person in the scene indicates that tag associated information is available about the tuxedo. In some embodiments, interactive content markers 2110 are not visible to the user during the movie experience as they distract from the viewing of the content. In some embodiments, one or more modes are provided in which interactive content markers 2110 can be displayed so that a user can see interactive content in the piece of content or in a scene of the piece of content.

When smart or interactive content is viewed, consumed, or activated by a user, a display may be activated with one or more icons wherein the user can point to those icons (such as by navigating using the remote cursor) to activate certain functions. For example, content 2100 may be associated with an interactive content icon 2120 and a bookmark icon 2130. Interactive content icon 2120 may include functionality that allows or enables a user to enable or disable one or more provided mode. Bookmark icon 2130 may include functionality that allows or enables a user to bookmark a scene, place, item, person, etc. in the piece of content so that the user can later go back to the bookmarked scene, place, item, person, etc. for further interaction with the content, landmarks, tags, TAI, etc.

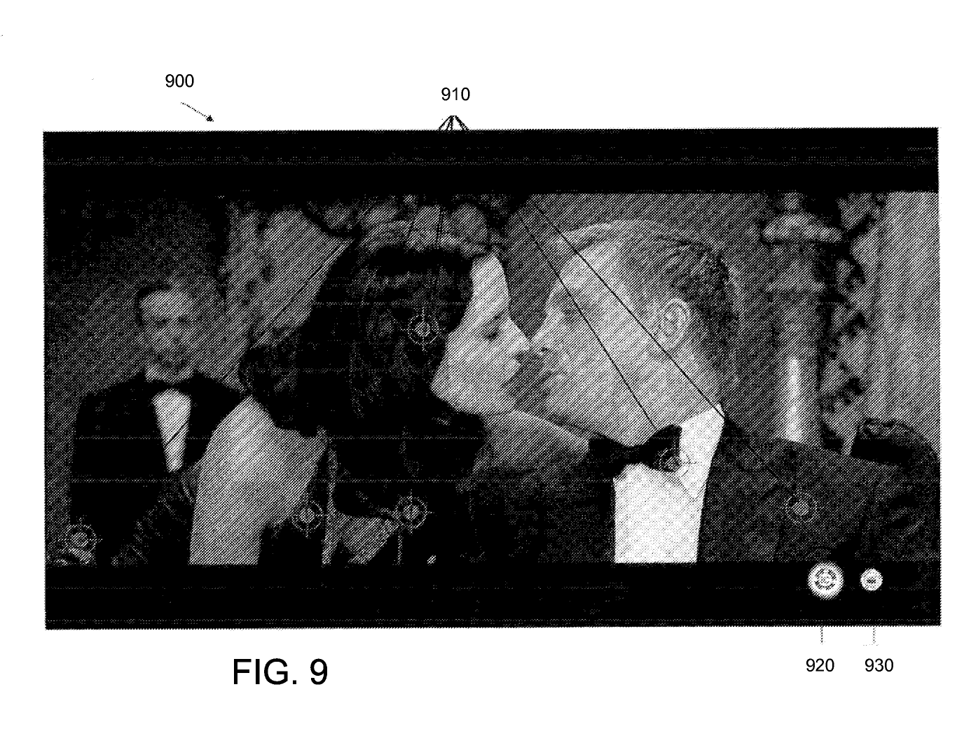

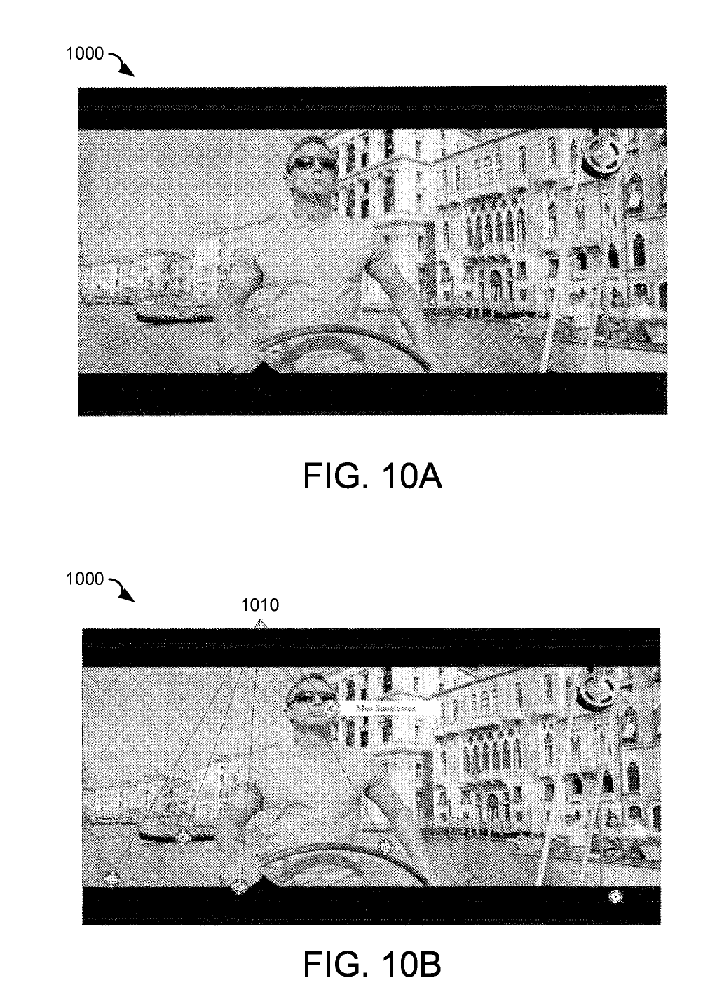

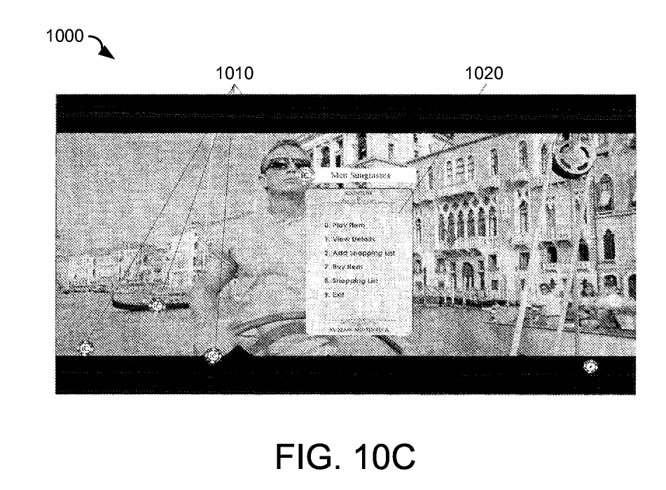

FIG. 10A illustrates scene 1000 from a piece of content being displayed to a user where landmarks are not activated. FIG. 10B illustrates scene 1000 from the piece of content where interactive content markers are activated by the user. As shown in 10B, one or more pieces of interactive content in scene 1000 are identified or represented, such as by interactive content markers 1010 wherein the user can select any one of interactive content markers 1010 using an on screen cursor or pointer. A particular visual icon used for interactive content markers 1010 can be customized to each piece of content. For example, when the piece of content has a gambling/poker theme, interactive content markers 1010 may be a poker chip as shown in the examples below. When the user selects an interactive content marker at or near a pair of sunglasses worn by a person in the scene as shown, the interactive content marker may also display a legend for the particular piece of interactive content (e.g., textual information providing the phrase “Men Sunglasses). In FIG. 10B, other pieces of interactive content may include a location (e.g., Venice, Italy), a gondola, a sailboat and the sunglasses.

FIG. 10C illustrates the scene from the piece of content in FIG. 10A when a menu user interface for interacting with smart content is displayed. For example, when a user selects a particular piece of interactive content, such as the sunglasses, menu 1020 maybe displayed to the user that gives the user several options to interact with the content. As shown, menu 1020 permits the user to: 1) play item/play scenes with item; 2) view details; 3) add to shopping list; 4) buy item; 5) see shopping list/cart; and 6) Exit or otherwise return to the content. In various embodiments, other options may be included such as 7) seeing “What's Hot;” 8) seeing “What's next;” or other bonus features or additional functionality.

In some embodiments, a “What's Hot” menu selection provides a user with interactive content (e.g., downloaded from one or more servers associated with platform 100 or other authorized 3^{rd} parties) about other products of the producer of the selected interactive content. For example, when the sunglasses are selected by a user, the “What's Hot” selection displays other products from the same manufacturer that might be of interest to the user which permits the manufacturer to show the products that are more appropriate for a particular time of year/location in which the user is watching the piece of content. Thus, even though the interactive content is not appropriate for the location/time of year that the user is watching the content, platform 100 permits the manufacturer of an item or other sponsors to show users different products or services (e.g., using the “What's Not” selection) that are more appropriate for the particular geographic location or time of year when the user is viewing the piece of content.

In another example, if the selected interactive content is a pair of sandals made by a particular manufacturer in a scene of the content on a beach during summer, but the user watching the content is watching the content in December in Michigan or is located in Greenland, the “What's Hot” selection allows the manufacturer to display boots, winter shoes, etc. made by the same manufacturer to the user which may be of interest to the user when the content is being watched or in the location in which the content is being watched.

In some embodiments, a “What's Next” menu selection provides the user with interactive content (e.g., downloaded from one or more servers associated with platform 100 or other authorized 3^{rd} parties) about newer/next versions of the interactive content to provide temporal advertising. For example, when the sunglasses are selected by a user, the “What's Next” selection displays newer or other versions of the sunglasses from the same manufacturer that might be of interest to the user. Thus, although the piece of content has an older model of the product, the “What's Next” selection allows the manufacturer to advertise the newer models or different related models of the products. Thus, platform 100 may incorporate features that prevent interactive content, tags, and TAI, from becoming stale and less valuable to the manufacturer such as when the product featured in the content is no longer made or sold.

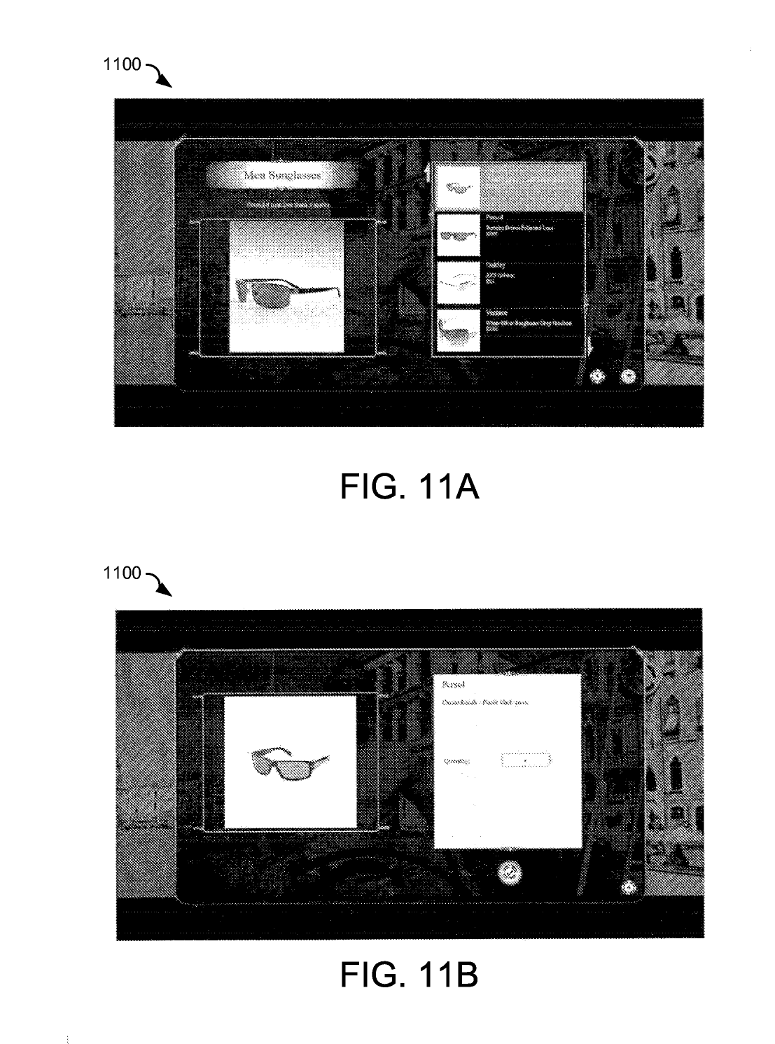

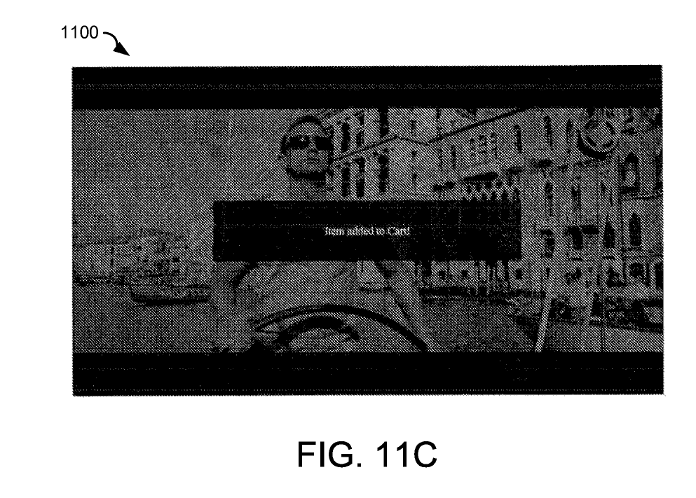

In further embodiments, a view details menu item causes platform 100 to send information to the user as a item detail user interface 80 as shown in FIG. 11A. Although the item shown in these examples is a product (the sunglasses), the item can also be a person, a location, a piece of music/soundtrack, a service, or the like wherein the details of item may be different for each of these different types of items. In the example in 11A, user interface 1100 shows details of the item as well as identification of stores from which the item can be purchased along with the prices at each store. The item detail display may also display one or more similar products (such as the Versace sunglasses or Oakley sunglasses) to the selected product that may also be of interest to the user. As shown in FIG. 11B, platform 100 allows users to add products or services to a shopping cart and provides feedback that that item is in the shopping cart as shown in FIG. 11C.

In further embodiments, a “See shopping list/cart” item causes platform 100 to display shopping cart user interface 1200 as shown in FIG. 12. A shopping cart can include typical shopping cart elements that are not described herein.

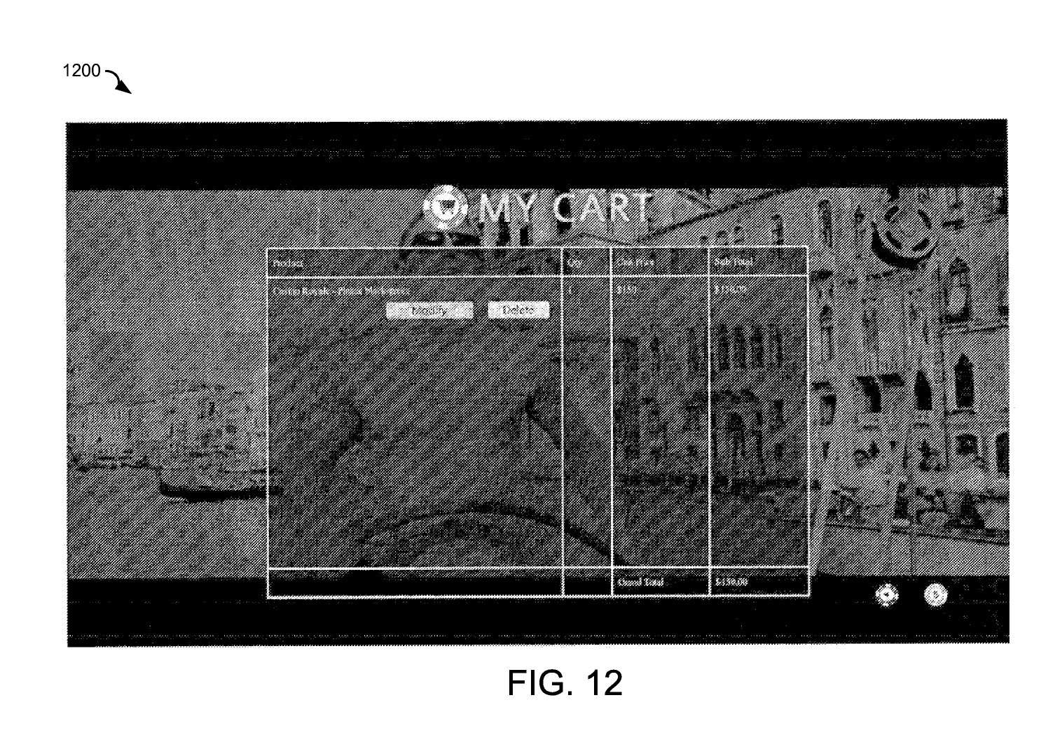

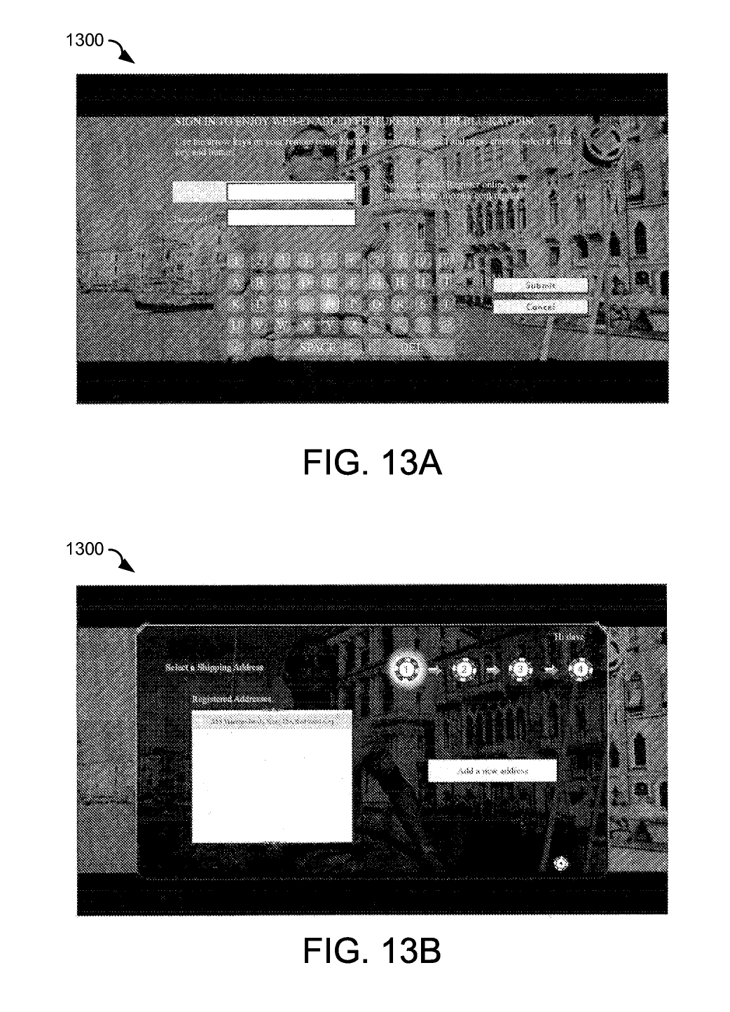

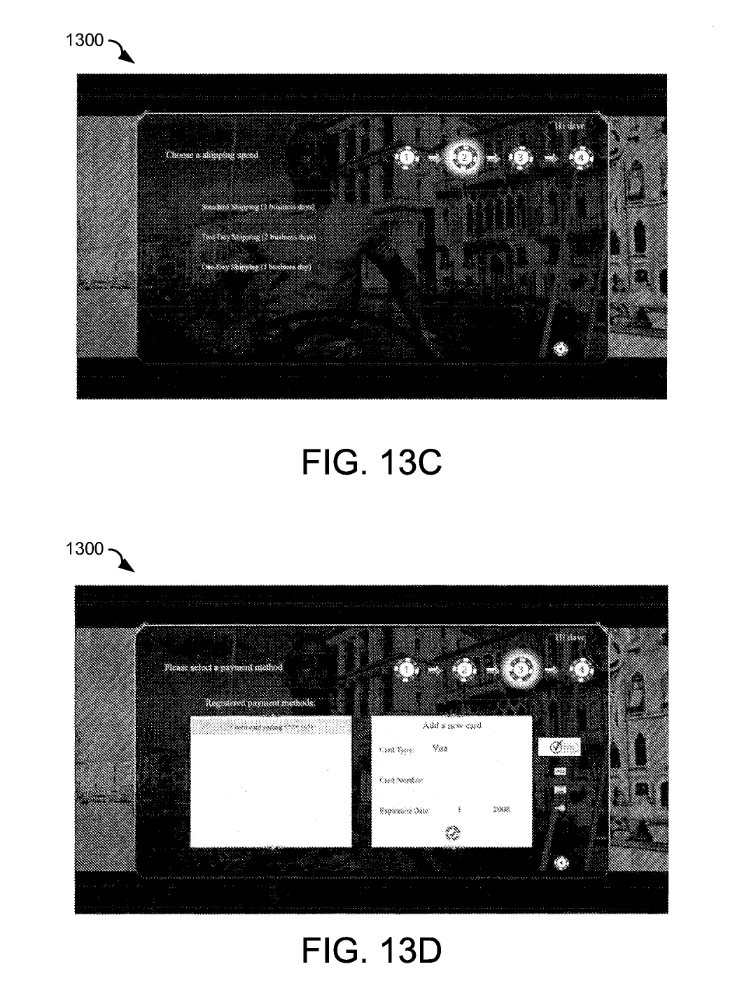

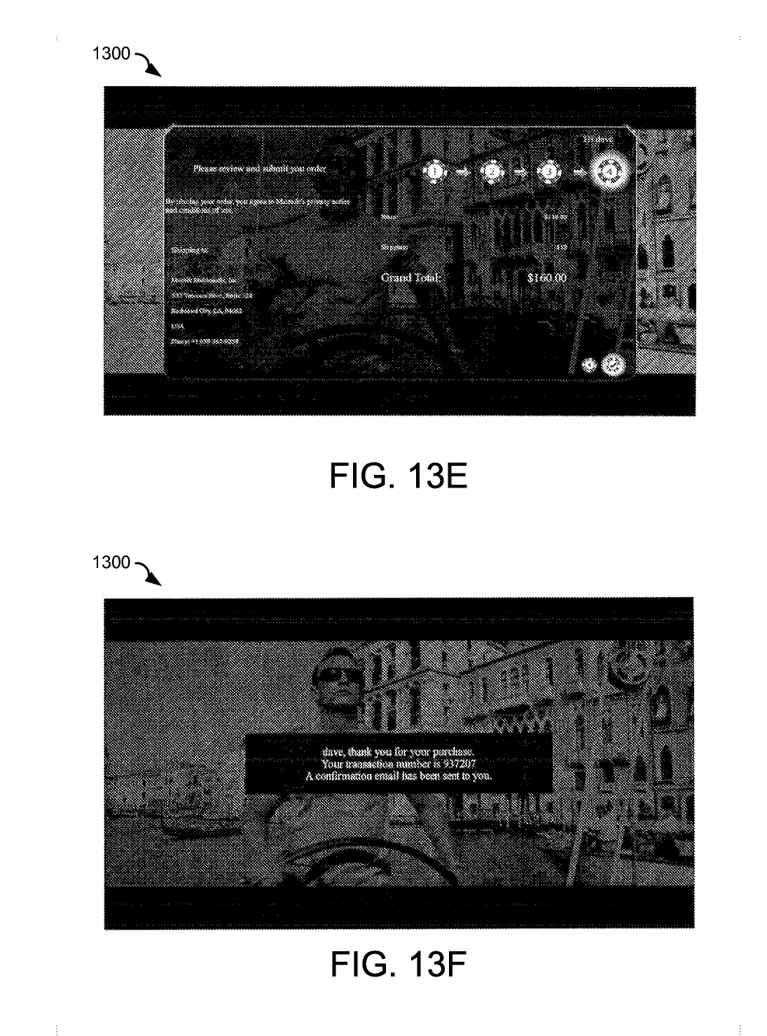

In various embodiments, as shown in FIG. 13A, platform 100 allows users to login to perform various operations such as the purchase of items in a shopping cart. When a user selects the “Buy Item” menu item or when exiting the shopping cart, platform 100 may include one or more ecommerce systems to permit the user to purchase the items in the shopping cart. Examples of user interfaces for purchasing items and/or interactive content are shown in FIGS. 13B, 13C, 13D, 13E, and 13F.

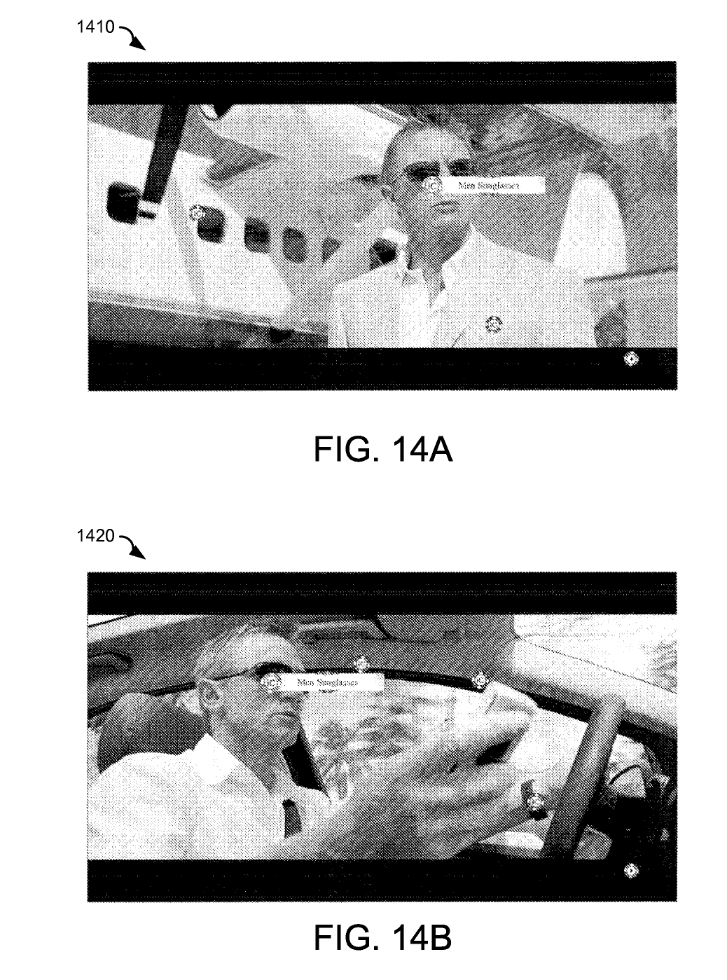

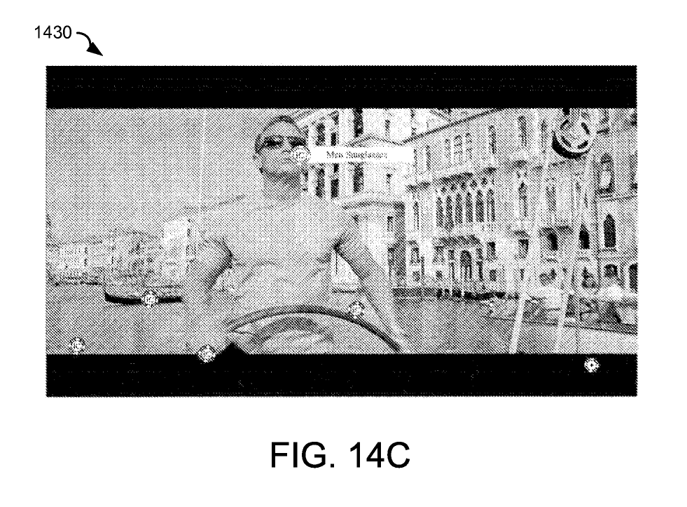

In further embodiments, a play item/play scene selection item causes platform 100 to show users each scene in the piece of content in which a selected piece of interactive content (e.g., an item, person, place, phrase, location, etc.) is displayed or referenced. In particular, FIGS. 14A, 14B, and 14C show several different scenes of a piece of content that have the same interactive content (the sunglasses in this example) in the scene. As discussed above, since platform 100 processes and metalogs each piece of content, platform 100 can identify each scene in which a particular piece of interactive content is show and then be capable of displaying all of these scenes to the user when requested.

In various embodiments, platform 100 may also provide a content search feature.

Content search may be based in part on the content, tags, and tag associated information. A search feature may allows users to take advantage of the interactive content categories (e.g., products, people, places/locations, music/soundtracks, services and/or words/phrases) to perform the search. A search feature may further allow users to perform a search in which multiple terms are connected to each other by logical operators. For example, a user can do a search for “Sarah Jessica Parker AND blue shoes” and may also specify the categories for each search term. Once a search is performed (e.g., at one or more servers associated with platform 100), search results can be displayed. In some embodiments, a user is able to view scenes in a piece of content that satisfy search criteria. In an alternative embodiment, local digital media may include code and functionality that allows some searching as described above to be performed, such as offline and without Internet connectivity.

Companion Devices

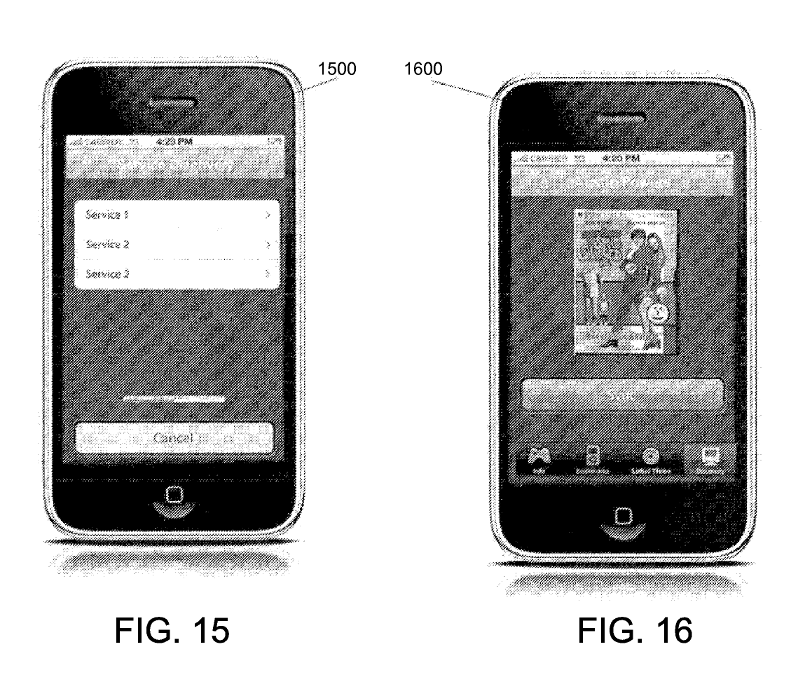

FIG. 15 illustrates an example of a user interface associated with computing device 1500 when computing device 1500 is used as a companion device in platform 100 of FIG. 1 in one embodiment according to the present invention. In various embodiments, computing device 1500 may automatically detect availability of interactive content and/or a communications link with one or more elements of platform 100. In further embodiments, a user may manually initiate communication between computing device 1500 and one or more elements of platform 100. In particular, a user may launch an interactive content application on computing device 1500 that sends out a multicast ping to content devices near computing device 1500 to establish a connection (wireless or wired) to the content devices for interactivity with platform 100.

FIG. 16 illustrates an example of a computing device user interface when computing device 1600 is being synched to a particular piece of content being consumed by a user in one embodiment according to the present invention. The user interface of FIG. 16 shows computing device 1600 in the process of establishing a connection. In a multiuser environment having multiple users, platform 100 permits the multiple users to establish a connection to one or more content devices so that each user can have their own, independent interactions with the content.

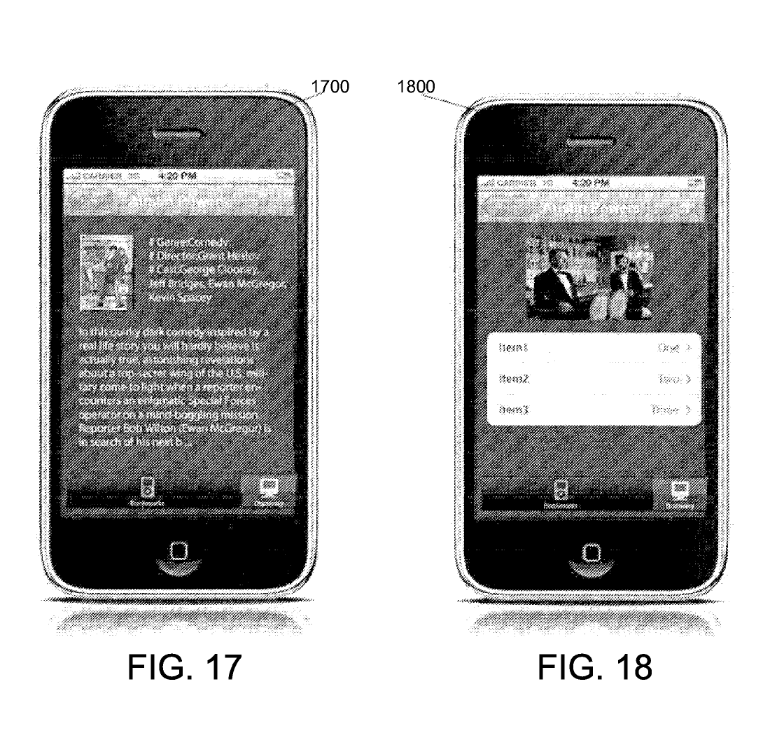

FIG. 17 illustrates an example of a computing device user interface showing details of a particular piece of content in one embodiment according to the present invention. In this example, computing device 1700 can be synchronized to a piece of content, such as the movie entitled “Austin Powers.” For example, computing device 1700 can be synchronized to the content automatically or by having a user select a sync button from a user interface. In further embodiments, once computing device 1700 has established a connection (e.g., either directly with a content playback device or indirectly through platform 100), computing device 1700 is provided with its own independent feed of content. Accordingly, in various embodiments, computing device 1700 can capture any portion of the content (e.g., a scene when the content is a movie). In further embodiments, each computing device in a multiuser environment can be provided with its own independent feed of content independent of the other computing devices.

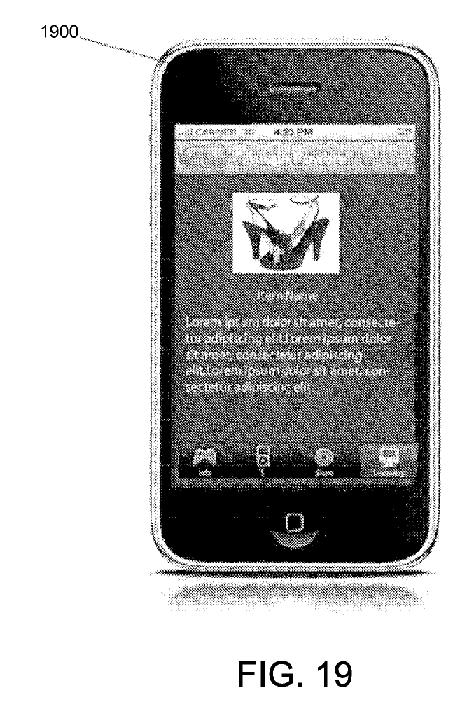

FIG. 18 illustrates an example of a computing device user interface once computing device 1800 is synched to a particular piece of content and has captured a scene in one embodiment according to the present invention. Once computing device 1800 has synched to a scene of the content, a user can perform a variety of interactivity operations (e.g., the same interactivity options discussed above—playitem/play scenes with item; view details; add to shopping list; buy item; see shopping list/cart; see “What's Hot”; and See “What's next” as described above). FIG. 19 illustrates an example of a computing device user interface of computing device 1900 when a user has selected a piece of interactive content in a synched scene of the piece of content in one embodiment according to the present invention.

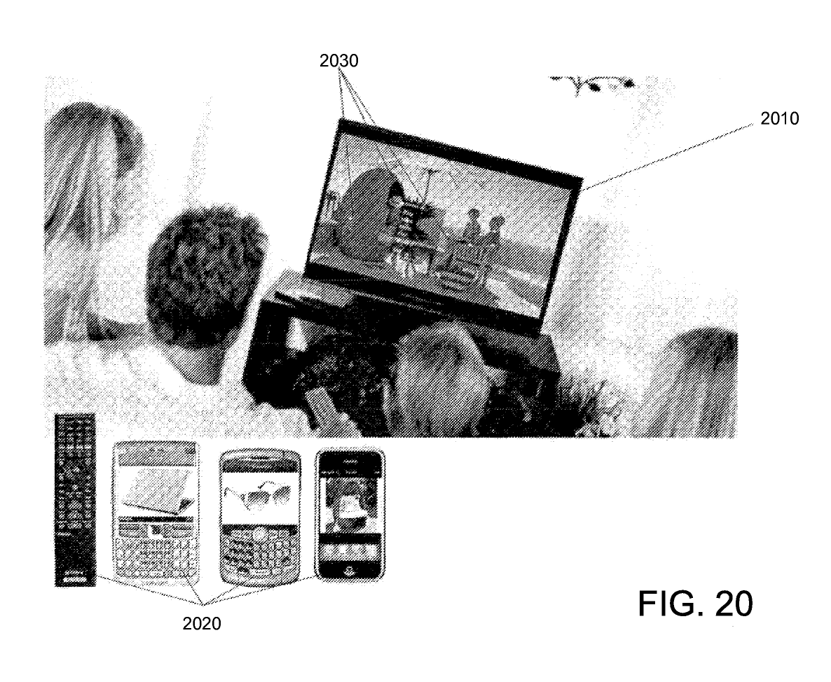

In various embodiments, a companion or computing device associated with platform 100 may also allow a user to share the scene/items, etc. with another user and/or comment on the piece of content. FIG. 20 illustrates multiple users each independently interacting with content using platform 100 of FIG. 1 in one embodiment according to the present invention. In one example, content device 2010 (e.g., a BD player or set top box and TV) may be displaying a movie and each user is using a particular computing device 2020 to view details of a different product in the scene being displayed wherein each of the products is marked using interactive content landmarks 2030 as described above. As shown in FIG. 20, one user is looking at the details of the laptop, while another user is looking at the glasses or the chair.

Smart Content Sharing

FIG. 21 is a flowchart of method 2100 for sharing tagged content in one embodiment according to the present invention. Method 2100 in FIG. 21 begins in step 2110.

In step 2120, an indication of a selected tag or portion of content is received. For example, a user may select a tag for an individual item or the user may select a portion of the content, such as a movie frame/clip.

In step 2130, an indication to share the tag or portion of content is received. For example, a user may click on a “Share This” link, or an icon to one or more social networking websites, such as Facebook, Linkedln, MySpace, Digg, Reddit, etc.

In step 2140, information is generated that enables other users to interact with the tag or portion of content via the social network. For example, platform may generate representations of the content, links, and coding or functionality that enable users of a particular social network to interact with the representations of the content to access TAI associated with the tag or portion of content.

In step 2150, the generated information is posted to the given social network. For example, a user's Facebook page may be updated to include one or more widgets, applications, portlets, or the like, that enable the user's online friends to interact the content (or representations of the content), select or mark any tags in the content or shared portion thereof, and access TAI associated with selected tags or marked portion of content. Users further may be able to interact with platform 100 to create user-generated tags and TAI for the shared tag or portion of content that then can be shared. FIG. 21 ends in step 2150.

Analytics

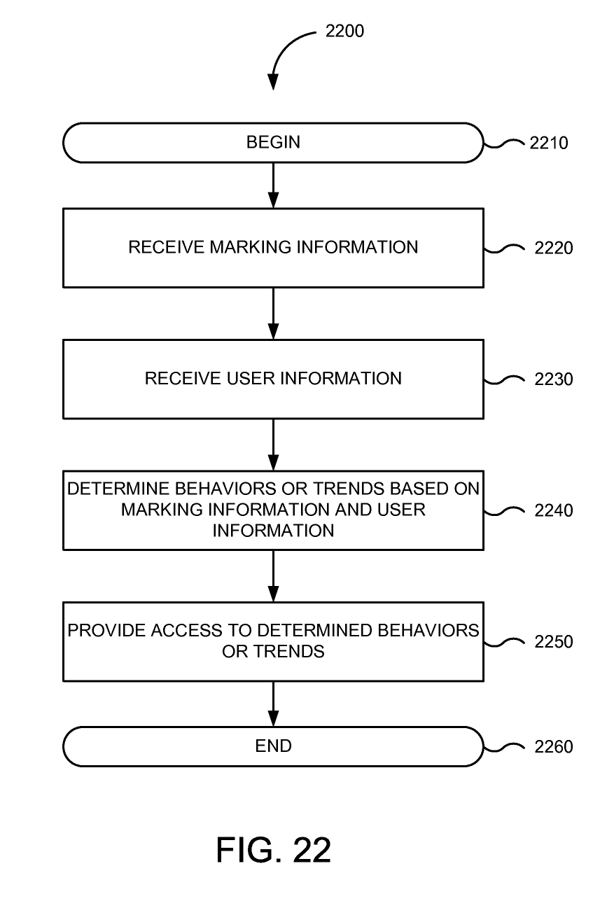

FIG. 22 is a flowchart of method 2200 for determining behaviors or trends from users interacting with tagged content in one embodiment according to the present invention. Method 2200 in FIG. 22 begins in step 2210.

In step 2220, marking information is received. Marking information may include information about tags marked or selected by a user, information about portions of content marked or selected by a user, information about entire selections of content, or the like. The marking information may be from an individual user, from one user session or over multiple user sessions. The marking information may further be from multiple users, covering multiple individual or aggregated sessions.

In step 2230, user information is received. The user information may include an individual user profile or multiple user profiles. The user information may include non-personally identifiable information and/or personally identifiable information.

In step 2240, one or more behaviors or trends may be determined based on the marking information and the user information. Behaviors or trends may be determined for content (e.g., what content is most popular), portions of content (e.g., what clips are being shared the most), items represented in content (e.g., the number of times during the past year users access information about a product featured in a product placement in a movie scene may be determined), or the like.

In step 2250, access is provided to the determined behaviors or trends. Content providers, advertisers, social scientists, marketers, or the like be use the determined behaviors or trends in developing new content, tags, TAI, or the like. FIG. 22 ends in step 2260.

Hardware and Software

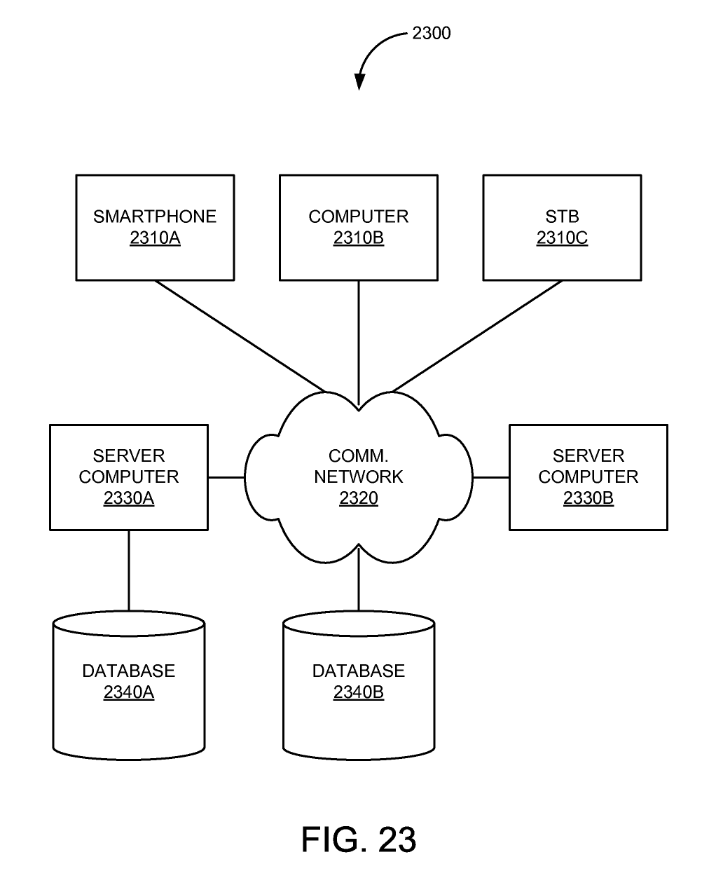

FIG. 23 is a simplified illustration of system 2300 that may incorporate an embodiment or be incorporated into an embodiment of any of the innovations, embodiments, and/or examples found within this disclosure. FIG. 2300 is merely illustrative of an embodiment incorporating the present invention and does not limit the scope of the invention as recited in the claims. One of ordinary skill in the art would recognize other variations, modifications, and alternatives.

In one embodiment, system 2300 includes one or more user computers or electronic devices 2310 (e.g., smartphone or companion device 2310A, computer 2310B, and set-top box 2310C). Computers or electronic devices 2310 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. Computers or electronic devices 2310 can also have any of a variety of applications, including one or more applications configured to perform methods of the invention, as well as one or more office applications, database client and/or server applications, and web browser applications.

Alternatively, computers or electronic devices 2310 can be any other consumer electronic device, such as a thin-client computer, Internet-enabled mobile telephone, and/or personal digital assistant, capable of communicating via a network (e.g., communications network 2320 described below) and/or displaying and navigating web pages or other types of electronic documents. Although the exemplary system 2300 is shown with three computers or electronic devices 2310, any number of user computers or devices can be supported. Tagging and displaying tagged items can be implemented on consumer electronics devices such as Camera and Camcorder. This could be done via touch screen or moving the cursor and selecting the objects and categorizing them.

Certain embodiments of the invention operate in a networked environment, which can include communications network 2320. Communications network 2320 can be any type of network familiar to those skilled in the art that can support data communications using any of a variety of commercially-available protocols, including without limitation TCP/IP, SNA, IPX, AppleTalk, and the like. Merely by way of example, communications network 2320 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, WIFI, he Bluetooth™ protocol known in the art, and/or any other wireless protocol; and/or any combination of these and/or other networks.

Embodiments of the invention can include one or more server computers 2330 (e.g., computers 2330A and 2330B). Each of server computers 2330 may be configured with an operating system including without limitation any of those discussed above, as well as any commercially-available server operating systems. Each of server computers 2330 may also be running one or more applications, which can be configured to provide services to one or more clients (e.g., user computers 2310) and/or other servers (e.g., server computers 2330).

Merely by way of example, one of server computers 2330 may be a web server, which can be used, merely by way of example, to process requests for web pages or other electronic documents from user computers 2310. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 2310 to perform methods of the invention.

Server computers 2330, in some embodiments, might include one ore more file and or/application servers, which can include one or more applications accessible by a client running on one or more of user computers 2310 and/or other server computers 2330. Merely by way of example, one or more of server computers 2330 can be one or more general purpose computers capable of executing programs or scripts in response to user computers 2310 and/or other server computers 2330, including without limitation web applications (which might, in some cases, be configured to perform methods of the invention).

Merely by way of example, a web application can be implemented as one or more scripts or programs written in any programming language, such as Java, C, or C++, and/or any scripting language, such as Perl, Python, or TCL, as well as combinations of any programming/scripting languages. The application server(s) can also include database servers, including without limitation those commercially available from Oracle, Microsoft, IBM and the like, which can process requests from database clients running on one of user computers 2310 and/or another of server computers 2330.

In some embodiments, an application server can create web pages dynamically for displaying the information in accordance with embodiments of the invention. Data provided by an application server may be formatted as web pages (comprising HTML, XML, Javascript, AJAX, etc., for example) and/or may be forwarded to one of user computers 2310 via a web server (as described above, for example). Similarly, a web server might receive web page requests and/or input data from one of user computers 2310 and/or forward the web page requests and/or input data to an application server.

In accordance with further embodiments, one or more of server computers 2330 can function as a file server and/or can include one or more of the files necessary to implement methods of the invention incorporated by an application running on one of user computers 2310 and/or another of server computers 2330. Alternatively, as those skilled in the art will appreciate, a file server can include all necessary files, allowing such an application to be invoked remotely by one or more of user computers 2310 and/or server computers 2330. It should be noted that the functions described with respect to various servers herein (e.g., application server, database server, web server, file server, etc.) can be performed by a single server and/or a plurality of specialized servers, depending on implementation-specific needs and parameters.

In certain embodiments, system 2300 can include one or more databases 2340 (e.g., databases 2340A and 2340B). The location of the database(s) 2320 is discretionary: merely by way of example, database 2340A might reside on a storage medium local to (and/or resident in) server computer 2330A (and/or one or more of user computers 2310). Alternatively, database 2340B can be remote from any or all of user computers 2310 and server computers 2330, so long as it can be in communication (e.g., via communications network 2320) with one or more of these. In a particular set of embodiments, databases 2340 can reside in a storage-area network (“SAN”) familiar to those skilled in the art. (Likewise, any necessary files for performing the functions attributed to user computers 2310 and server computers 2330 can be stored locally on the respective computer and/or remotely, as appropriate). In one set of embodiments, one or more of databases 2340 can be a relational database that is adapted to store, update, and retrieve data in response to SQL-formatted commands. Databases 2340 might be controlled and/or maintained by a database server, as described above, for example.

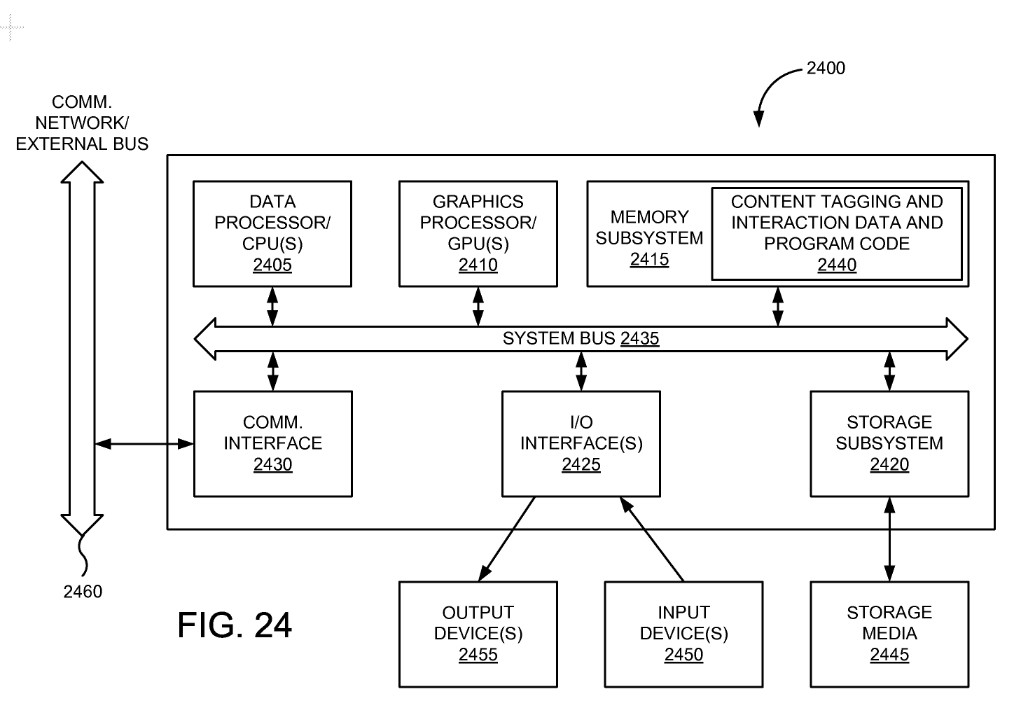

FIG. 24 is a block diagram of computer system 2400 that may incorporate an embodiment, be incorporated into an embodiment, or be used to practice any of the innovations, embodiments, and/or examples found within this disclosure. FIG. 24 is merely illustrative of a computing device, general-purpose computer system programmed according to one or more disclosed techniques, specific information processing device or consumer electronic device for an embodiment incorporating an invention whose teachings may be presented herein and does not limit the scope of the invention as recited in the claims. One of ordinary skill in the art would recognize other variations, modifications, and alternatives.

Computer system 2400 can include hardware and/or software elements configured for performing logic operations and calculations, input/output operations, machine communications, or the like. Computer system 2400 may include familiar computer components, such as one or more one or more data processors or central processing units (CPUs) 2405, one or more graphics processors or graphical processing units (GPUs) 2410, memory subsystem 2415, storage subsystem 2420, one or more input/output (I/O) interfaces 2425, communications interface 2430, or the like. Computer system 2400 can include system bus 2435 interconnecting the above components and providing functionality, such connectivity and inter-device communication. Computer system 2400 may be embodied as a computing device, such as a personal computer (PC), a workstation, a mini-computer, a mainframe, a cluster or farm of computing devices, a laptop, a notebook, a netbook, a PDA, a smartphone, a consumer electronic device, a gaming console, or the like.

The one or more data processors or central processing units (CPUs) 2405 can include hardware and/or software elements configured for executing logic or program code or for providing application-specific functionality. Some examples of CPU(s) 2405 can include one or more microprocessors (e.g., single core and multi-core) or micro-controllers. CPUs 2405 may include 4-bit, 8-bit, 12-bit, 16-bit, 32-bit, 64-bit, or the like architectures with similar or divergent internal and external instruction and data designs. CPUs 2405 may further include a single core or multiple cores. Commercially available processors may include those provided by Intel of Santa Clara, California (e.g., x86, x86_{—}64, PENTIUM, CELERON, CORE, CORE 2, CORE ix, ITANIUM, XEON, etc.), by Advanced Micro Devices of Sunnyvale, Calif. (e.g., x86, AMD_{—}64, ATHLON, DURON, TURION, ATHLON XP/64, OPTERON, PHENOM, etc). Commercially available processors may further include those conforming to the Advanced RISC Machine (ARM) architecture (e.g., ARMv7-9), POWER and POWERPC architecture, CELL architecture, and or the like. CPU(s) 2405 may also include one or more field-gate programmable arrays (FPGAs), application-specific integrated circuits (ASICs), or other microcontrollers. The one or more data processors or central processing units (CPUs) 2405 may include any number of registers, logic units, arithmetic units, caches, memory interfaces, or the like. The one or more data processors or central processing units (CPUs) 2405 may further be integrated, irremovably or moveably, into one or more motherboards or daughter boards.

The one or more graphics processor or graphical processing units (GPUs) 2410 can include hardware and/or software elements configured for executing logic or program code associated with graphics or for providing graphics-specific functionality. GPUs 2410 may include any conventional graphics processing unit, such as those provided by conventional video cards. Some examples of GPUs are commercially available from NVIDIA, ATI, and other vendors. In various embodiments, GPUs 2410 may include one or more vector or parallel processing units. These GPUs may be user programmable, and include hardware elements for encoding/decoding specific types of data (e.g., video data) or for accelerating operations, or the like. The one or more graphics processors or graphical processing units (GPUs) 2410 may include any number of registers, logic units, arithmetic units, caches, memory interfaces, or the like. The one or more data processors or central processing units (CPUs) 2405 may further be integrated, irremovably or moveably, into one or more motherboards or daughter boards that include dedicated video memories, frame buffers, or the like.

Memory subsystem 2415 can include hardware and/or software elements configured for storing information. Memory subsystem 2415 may store information using machine-readable articles, information storage devices, or computer-readable storage media. Some examples of these articles used by memory subsystem 2470 can include random access memories (RAM), read-only-memories (ROMS), volatile memories, non-volatile memories, and other semiconductor memories. In various embodiments, memory subsystem 2415 can include content tagging and/or smart content interactivity data and program code 2440.

Storage subsystem 2420 can include hardware and/or software elements configured for storing information. Storage subsystem 2420 may store information using machine-readable articles, information storage devices, or computer-readable storage media. Storage subsystem 2420 may store information using storage media 2445. Some examples of storage media 2445 used by storage subsystem 2420 can include floppy disks, hard disks, optical storage media such as CD-ROMS, DVDs and bar codes, removable storage devices, networked storage devices, or the like. In some embodiments, all or part of content tagging and/or smart content interactivity data and program code 2440 may be stored using storage subsystem 2420.

In various embodiments, computer system 2400 may include one or more hypervisors or operating systems, such as WINDOWS, WINDOWS NT, WINDOWS XP, VISTA, WINDOWS 7 or the like from Microsoft of Redmond, Wash., Mac OS or Mac OS X from Apple Inc. of Cupertino, Calif., SOLARIS from Sun Microsystems, LINUX, UNIX, and other UNIX-based or UNIX-like operating systems. Computer system 2400 may also include one or more applications configured to execute, perform, or otherwise implement techniques disclosed herein. These applications may be embodied as content tagging and/or smart content interactivity data and program code 2440. Additionally, computer programs, executable computer code, human-readable source code, or the like, may be stored in memory subsystem 2415 and/or storage subsystem 2420.

The one or more input/output (I/O) interfaces 2425 can include hardware and/or software elements configured for performing I/O operations. One or more input devices 2450 and/or one or more output devices 2455 may be communicatively coupled to the one or more I/O interfaces 2425.

The one or more input devices 2450 can include hardware and/or software elements configured for receiving information from one or more sources for computer system 2400. Some examples of the one or more input devices 2450 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 2450 may allow a user of computer system 2400 to interact with one or more non-graphical or graphical user interfaces to enter a comment, select objects, icons, text, user interface widgets, or other user interface elements that appear on a monitor/display device via a command, a click of a button, or the like.

The one or more output devices 2455 can include hardware and/or software elements configured for outputting information to one or more destinations for computer system 2400. Some examples of the one or more output devices 2455 can include a printer, a fax, a feedback device for a mouse or joystick, external storage systems, a monitor or other display device, a communications interface appropriately configured as a transceiver, or the like. The one or more output devices 2455 may allow a user of computer system 2400 to view objects, icons, text, user interface widgets, or other user interface elements.

A display device or monitor may be used with computer system 2400 and can include hardware and/or software elements configured for displaying information. Some examples include familiar display devices, such as a television monitor, a cathode ray tube (CRT), a liquid crystal display (LCD), or the like.

Communications interface 2430 can include hardware and/or software elements configured for performing communications operations, including sending and receiving data. Some examples of communications interface 2430 may include a network communications interface, an external bus interface, an Ethernet card, a modem (telephone, satellite, cable, ISDN), (asynchronous) digital subscriber line (DSL) unit, FireWire interface, USB interface, or the like. For example, communications interface 2430 may be coupled to communications network/external bus 2480, such as a computer network, to a FireWire bus, a USB hub, or the like. In other embodiments, communications interface 2430 may be physically integrated as hardware on a motherboard or daughter board of computer system 2400, may be implemented as a software program, or the like, or may be implemented as a combination thereof

In various embodiments, computer system 2400 may include software that enables communications over a network, such as a local area network or the Internet, using one or more communications protocols, such as the HTTP, TCP/IP, RTP/RTSP protocols, or the like. In some embodiments, other communications software and/or transfer protocols may also be used, for example IPX, UDP or the like, for communicating with hosts over the network or with a device directly connected to computer system 2400.

As suggested, FIG. 24 is merely representative of a general-purpose computer system appropriately configured or specific data processing device capable of implementing or incorporating various embodiments of an invention presented within this disclosure. Many other hardware and/or software configurations may be apparent to the skilled artisan which are suitable for use in implementing an invention presented within this disclosure or with various embodiments of an invention presented within this disclosure. For example, a computer system or data processing device may include desktop, portable, rack-mounted, or tablet configurations. Additionally, a computer system or information processing device may include a series of networked computers or clusters/grids of parallel processing devices. In still other embodiments, a computer system or information processing device may perform techniques described above as implemented upon a chip or an auxiliary processing board.

Various embodiments of any of one or more inventions whose teachings may be presented within this disclosure can be implemented in the form of logic in software, firmware, hardware, or a combination thereof The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A method for providing an interactive user experience, the method comprising:
receiving, at one or more computer systems, one or more tags associated with content, each tag corresponding to at least one item represented in the content;
determining, with one or more processors associated with the one or more computer systems, what information to associate with each tag in the one or more tags;
generating, with the one or more processors associated with the one or more computer systems, one or more links between each tag in the one or more tags and determined information based on a set of business rules; and
storing the one or more links in a repository accessible to the one or more computer systems and at least one consumer of the content such that selection of a tag in the one or more tags by the consumer of the content causes determined information associated with the tag to be presented to the consumer of the content.

2. The method of claim 1 wherein each of receive, determining, generating, and storing steps are performed in response to one-step tagging.

3. The method of claim 1 wherein at least one of the one or more tags are generated by a producer of the content.

4. The method of claim 3 wherein determining what information to associate with each tag in the one or more tags comprises receiving tag associated information from the producer of the content.

5. The method of claim 1 wherein at least one of the one or more tags are user-generated.

6. The method of claim 5 wherein determining what information to associate with each tag in the one or more tags comprises receiving user-specified tag associated information.

7. The method of claim 1 wherein the at least one item represented in the content comprises at least one of a location, a structure, a person, a good, or a service.

8. The method of claim 1 wherein determining, with one or more processors associated with the one or more computer systems, what information to associate with each tag in the one or more tags comprises:
determining one or more information sources;
querying the one or more information sources; and
receiving results from the one or more information sources.

9. The method of claim 8 wherein generating the one or more links between each tag in the one or more tags and determined information based on the set of business rules comprises associating a portion of the results from the one or more information sources with a tag in the one or more tags.

10. The method of claim 8 wherein generating the one or more links between each tag in the one or more tags and determined information based on the set of business rules comprises associating at least one action in the results from the one or more information sources with a tag in the one or more tags.

11. The method of claim 1 further comprising generating one or more updated links between each tag in the one or more tags and determined information based on the set of business rules.

12. The method of claim 1 further comprising receiving, at the one or more computer systems, marking information; and
determining one or more trends or behaviors based on the marking information.

13. A non-transitory computer-readable medium storing executable code for providing an interactive user experience, the computer-readable medium comprising:
code for receiving one or more tags associated with content, each tag corresponding to at least one item represented in the content;
code for determining what information to associate with each tag in the one or more tags;
code for generating one or more links between each tag in the one or more tags and determined information based on a set of business rules; and
code for storing the one or more links in a repository accessible to at least one consumer of the content such that selection of a tag in the one or more tags by the consumer of the content causes determined information associated with the tag to be presented to the consumer of the content.

14. The computer-readable medium of claim 13 wherein the at least one item represented in the content comprises at least one of a location, a structure, a person, a good, or a service.

15. The computer-readable medium of claim 13 wherein the code for determining what information to associate with each tag in the one or more tags comprises:
code for determining one or more information sources;
code for querying the one or more information sources; and
code for receiving results from the one or more information sources.

16. The computer-readable medium of claim 15 wherein the code for generating the one or more links between each tag in the one or more tags and determined information based on the set of business rules comprises code for associating a portion of the results from the one or more information sources with a tag in the one or more tags.

17. The computer-readable medium of claim 15 wherein the code for generating the one or more links between each tag in the one or more tags and determined information based on the set of business rules comprises code for associating at least one action in the results from the one or more information sources with a tag in the one or more tags.

18. The computer-readable medium of claim 13 further comprising code for generating one or more updated links between each tag in the one or more tags and determined information based on the set of business rules.

19. The computer-readable medium of claim 13 further comprising code for receiving marking information; and
code for determining one or more trends or behaviors based on the marking information.

20. An electronic device comprising:
a processor; and
a memory in communication with the processor and configured to store code executable by the processor that configures the processor to:
receive an indication of a selected tag;
receive tag associated information based on the selected tag; and
output the tag associated information.
